(19) United States
(12) Patent Application Publication
(10) Pub. No.: US 2024/0003708 A1
(43) Pub. Date: Jan. 4, 2024

(54) MAP UPDATE METHOD AND APPARATUS, AND MAP-BASED DRIVING DECISION-MAKING METHOD AND APPARATUS

(71) Applicant: HUAWEI TECHNOLOGIES CO., LTD., Shenzhen (CN)

(72) Inventors: Zheng Zhou, Beijing (CN); Tao Ma, Beijing (CN); Youlei Chen, Shenzhen (CN); Yong Wang, Shenzhen (CN)

(21) Appl. No.: 18/468,620

(22) Filed: Sep. 15, 2023

Related U.S. Application Data
(63) Continuation of application No. PCT/CN2022/079810, filed on Mar. 9, 2022.

(30) Foreign Application Priority Data
Mar. 16, 2021 (CN) 202110280778.2

(51) Int. Cl. G01C 21/00; B60W 60/00

(52) U.S. Cl. CPC G01C 21/3833; G01C 21/3881; G01C 21/3896; B60W 60/001; B60W 2556/20; B60W 2556/40; B60W 2556/50

(57) ABSTRACT

A map update method and apparatus, and a map-based driving decision-making method and apparatus are provided and applied to a vehicle. The map update method includes: obtaining tile update information of a map, where the tile update information indicates a changed tile of the map; determining a to-be-updated tile based on a pinpointed location of the vehicle, a navigation path of the vehicle, and the tile update information, where the to-be-updated tile is a part of tiles in the changed tile; downloading the to-be-updated tile from a server; updating the map based on the downloaded to-be-updated tile; and performing driving decision-making based on the updated map.

### CROSS-REFERENCE TO RELATED APPLICATIONS

This application is a continuation of International Application No. PCT/CN2022/079810, filed on Mar. 9, 2022, which claims priority to Chinese Patent Application No. 202110280778.2, filed on Mar. 16, 2021. The disclosures of the aforementioned applications are hereby incorporated by reference in their entireties.

### TECHNICAL FIELD

This application relates to the technical field of Internet of Vehicles, and in particular, to a map update method and apparatus, and a map-based driving decision-making method and apparatus.

### BACKGROUND

With rapid development of autonomous driving technologies, there are increasingly more fields in which autonomous vehicles are used, and lots of universities, automobile enterprises, and Internet enterprises invest heavily in scientific researches on autonomous vehicles. An autonomous vehicle is a comprehensive intelligent system that integrates a plurality of functions such as navigation, environment perception, decision-making and planning, and human-machine interaction.

An autonomous driving technology relies on use of a high-definition map (HD Map). The high-definition map is a map of high positioning accuracy with data that can be updated in real time. Different from a conventional navigation map, in addition to road-level navigation information, the high-definition map can further provide lane-level navigation information. The high-definition map is mainly used for assisted driving or autonomous driving, and provides lane-level planning and vehicle positioning assistance in a road section for a vehicle.

With real-time changes of an environment, the high-definition map is frequently updated. Because there is a large amount of data for the high-definition map, a user may not be able to download an updated data package of the high-definition map in time. As a result, a vehicle cannot obtain tile update information of the map when moving, causing a security risk to the user.

### SUMMARY

This application provides a map update method and apparatus, and a map-based driving decision-making method and apparatus, to obtain latest map update information in time, thereby better assisting navigation or autonomous driving.

According to a first aspect, this application provides a map update method that is applied to a vehicle or a module or chip, on a vehicle, having a map update function, and that may be further applied to a module or chip, on the vehicle, having a map-based driving decision-making function. The method includes: obtaining tile update information of a map, where the tile update information indicates a changed tile of the map; determining a to-be-updated tile based on a pinpointed location of the vehicle, a navigation path of the vehicle, and the tile update information, where the to-be-updated tile is a part of tiles in the changed tile; downloading the to-be-updated tile from a server; updating the map based on the downloaded to-be-updated tile; and performing driving decision-making based on the updated map.

According to the foregoing method, after determining the to-be-updated tile based on the changed tile, the pinpointed location of the vehicle, and the navigation path of the vehicle, the vehicle downloads the to-be-updated tile from the server. The to-be-updated tile may be used for driving decision-making, and therefore can be used while being updated. A part of updated tiles may be used for driving decision-making without a need to wait for an update of all tiles of the map to be completed or a need to wait for an update of all changed tiles of the map to be completed. In addition, because the to-be-updated tile is related to the location and the navigation path of the vehicle, timeliness and accuracy of tile information currently used for driving decision-making can be ensured, to better assist navigation or autonomous driving.

In a possible implementation, the vehicle may determine, based on the pinpointed location and the navigation path, a tile at which the vehicle is about to arrive; and determine the to-be-updated tile based on the tile at which the vehicle is about to arrive and the changed tile.

According to the foregoing method, the vehicle may determine, based on the pinpointed location of the vehicle and the navigation path of the vehicle, whether there is a changed tile at the pinpointed location of the vehicle, and determine, based on the navigation path of the vehicle, whether there is a changed tile at a location at which the vehicle is about to arrive, for example, whether there is a changed tile at a location at which the vehicle is about to arrive within a preset time in the future. In this way, the to-be-updated tile may be determined based on the tile at which the vehicle is about to arrive and the changed tile. In this way, the vehicle preferentially downloads a tile corresponding to the location at which the vehicle is about to arrive, to ensure that the tile has been downloaded when the vehicle arrives at the location and the map has been updated based on the tile that can be used for driving decision-making. This ensures that a corresponding driving decision-making function can be used smoothly, to better assist navigation or autonomous driving.

In a possible implementation, the method further includes: determining an order of downloading the to-be-updated tile based on at least one of the following information: a requirement of the driving decision-making on using the to-be-updated tile; a driving type of the vehicle; a data type of the to-be-updated tile; or information about a similarity between the to-be-updated tile and a tile stored on the vehicle.

According to the foregoing method, the vehicle may further determine the order of downloading the to-be-updated tile, so that downloading of the to-be-updated tile can adapt to requirements in more scenarios. For example, with different data types of the to-be-updated tile, a tile that is more closely related to driving safety may be preferentially downloaded. When driving of the vehicle is autonomous driving, a tile related to autonomous driving is preferentially downloaded based on a requirement of autonomous driving. In this way, a driving requirement at a current moment is preferentially satisfied, so that an update of the map can adapt to driving of the vehicle.

In a possible implementation, an order of using the to-be-updated tile corresponding to driving decision-making performed by the vehicle is determined based on an area at which the vehicle is about to arrive. The order of downloading the to-be-updated tile or an order of using the to-be-updated tile for updating the map is determined based on the order of using the to-be-updated tile corresponding to driving decision-making performed by the vehicle.

In a possible implementation, a priority of using the to-be-updated tile corresponding to driving decision-making performed by the vehicle is determined based on the area at which the vehicle is about to arrive. A priority of downloading the to-be-updated tile or a priority of using the to-be-updated tile for updating the map is determined based on the priority of using the to-be-updated tile corresponding to driving decision-making performed by the vehicle.

According to the foregoing method, the vehicle may determine, based on the area at which the vehicle is about to arrive, the order of using the to-be-updated tile corresponding to driving decision-making performed by the vehicle. For example, the area at which the vehicle is about to arrive corresponds to a tile 1→a tile 2, and it may be determined that the vehicle preferentially uses the tile 1 and the tile 2 for driving decision-making. Therefore, it may be determined that the tile 1 is first downloaded, and then the tile 2 is downloaded, to preferentially satisfy a driving requirement at a current moment and satisfy a requirement of using the map for driving decision-making.

In a possible implementation, the method further includes: determining an order of updating the to-be-updated tile based on at least one of the following information: the requirement of the driving decision-making on using the to-be-updated tile; the driving type of the vehicle; the data type of the to-be-updated tile; or the information about the similarity between the to-be-updated tile and the tile stored on the vehicle.

According to the foregoing method, the vehicle may further determine the order of updating the to-be-updated tile based on the foregoing information. For example, when the vehicle can download a large quantity of to-be-updated tiles, considering that it takes corresponding time for the vehicle to update the map, a to-be-updated tile that satisfies the foregoing information may be preferentially updated based on a driving requirement of the vehicle, so that an update of the map can adapt to driving of the vehicle.

According to a second aspect, an embodiment of this application provides a map update method that is applied to a server and that includes: sending tile update information of a map to a vehicle, where the tile update information indicates a changed tile of the map; obtaining information about a to-be-updated tile, where the to-be-updated tile is a part of tiles in the changed tile; and sending the to-be-updated tile to the vehicle.

According to the foregoing method, after the server determines the to-be-updated tile based on the changed tile, the pinpointed location of the vehicle, and the navigation path of the vehicle, the server may send the to-be-updated tile to the vehicle. The to-be-updated tile may be used for driving decision-making, and therefore the map can be used while being updated. A part of updated tiles may be used for driving decision-making without a need to wait for an update of all tiles of the map to be completed or a need to wait for an update of all changed tiles of the map to be completed. In addition, because the to-be-updated tile is related to the location and the navigation path of the vehicle, timeliness and accuracy of tile information currently used for driving decision-making can be ensured, to better assist navigation or autonomous driving.

In some embodiments, the server may determine the to-be-updated tile based on a part of tiles in the changed tile. For example, in a possible implementation, the server may obtain a pinpointed location of the vehicle and a navigation path of the vehicle; and determine the to-be-updated tile based on the tile update information, the pinpointed location, and the navigation path.

According to the foregoing method, the server may determine the information about the to-be-updated tile based on related information of the vehicle, for example, the pinpointed location of the vehicle and the navigation path of the vehicle; and the tile update information. With a powerful processing capability of the server, overheads for the vehicle to determine the to-be-updated tile are saved, and interaction between the vehicle and the server is reduced, to adapt to a scenario in which a processing capability of the vehicle is limited.

For example, the server may determine, based on the pinpointed location and the navigation path, a tile at which the vehicle is about to arrive; and determine the to-be-updated tile based on the tile at which the vehicle is about to arrive and the changed tile.

According to the foregoing method, the server may determine the to-be-updated tile based on the tile at which the vehicle is about to arrive and the changed tile. In this way, the vehicle preferentially downloads a tile corresponding to the location at which the vehicle is about to arrive, to ensure that the tile has been downloaded when the vehicle arrives at the location and the map has been updated based on the tile that can be used for driving decision-making. This ensures that a corresponding driving decision-making function can be used smoothly, to better assist navigation or autonomous driving.

In some other embodiments, alternatively, after determining the information about the to-be-updated tile, the vehicle sends the information about the to-be-updated tile to the server. For example, in a possible implementation, the server may receive the information about the to-be-updated tile that is sent from the vehicle, and the information about the to-be-updated tile is determined based on the tile update information, the pinpointed location of the vehicle, and the navigation path of the vehicle.

According to the foregoing method, the server may send the to-be-updated tile to the vehicle based on the information about the to-be-updated tile that is determined by the vehicle. In this way, the vehicle is given more freedom to determine the to-be-updated tile, overheads of the server are correspondingly reduced, and an update delay on the vehicle caused by excessive tasks processed by the server is reduced.

A specific implementation may be determined based on a requirement. A plurality of solutions for the server to obtain the information about the to-be-updated tile are provided for more flexibly adapting to a plurality of application scenarios.

In a possible implementation, the server may determine an order of downloading the to-be-updated tile based on at least one of the following information: a requirement of the driving decision-making on using the to-be-updated tile; a driving type of the vehicle; a data type of the to-be-updated tile; or information about a similarity between the to-be-updated tile and a tile stored on the vehicle.

According to the foregoing method, a manner of the server of sending the to-be-updated tile can more flexibly adapt to requirements in more scenarios. For example, with different data types of the to-be-updated tile, a tile that is more closely related to driving safety may be preferentially sent. When driving of the vehicle is autonomous driving, a tile related to autonomous driving is preferentially sent based on a requirement of autonomous driving. In this way, a requirement of driving the vehicle at a current moment is preferentially satisfied, so that an update of the map can adapt to driving of the vehicle.

In a possible implementation, the server may determine an order of updating the to-be-updated tile based on at least one of the following information: the requirement of the driving decision-making on using the to-be-updated tile; the driving type of the vehicle; the data type of the to-be-updated tile; or the information about the similarity between the to-be-updated tile and the tile stored on the vehicle.

According to the foregoing method, the server may determine the order of updating the to-be-updated tile based on a driving requirement of the vehicle. Optionally, the server may send the order of updating the to-be-updated tile, to instruct the vehicle to update the to-be-updated tile according to the order of updating. For example, when the vehicle can download a large quantity of to-be-updated tiles, considering that it takes corresponding time for the vehicle to update the map, a to-be-updated tile that satisfies the foregoing information may be preferentially updated based on the driving requirement of the vehicle, so that an update of the map can adapt to driving of the vehicle.

According to a third aspect, this application provides a map-based driving decision-making method that is applied to a vehicle or a module or a chip, on a vehicle, having a map-based driving decision-making function. The method includes: obtaining tile update information of a map, where the tile update information indicates a changed tile of the map, and the tile update information includes information about confidence of the changed tile; and selecting, based on the information about the confidence, a part of tiles in the changed tile to be a reference tile for driving decision-making.

According to the foregoing method, the vehicle may obtain the information about the confidence of the changed tile based on the tile update information of the map, and then the vehicle may select, based on the information about the confidence, the reference tile for driving decision-making, so that there is no need to download all tiles of the map, and there is no need to download all changed tiles of the map. In other words, driving decision-making may be performed when only a part of tiles are updated, to improve timeliness and accuracy of assisting driving decision-making based on map information.

Specifically, the information about the confidence may indicate an absolute reliability of map information after the tile changes. The vehicle preferentially selects and updates a tile of a high absolute reliability, and performs driving decision-making after the tile of a high absolute reliability has been updated, not after all changed tiles have been updated. In addition, the information about the confidence may alternatively indicate a relative similarity between the map information after the tile changes and map information before the tile changes. For example, if the relative similarity is low, it indicates that the map information before the tile changes is no longer suitable for being used as reference information for driving decision-making, and the tile needs to be updated, and updated map information is used for driving decision-making; or if a relative similarity is high, it indicates that the map information before the tile changes may be used for driving decision-making, and the map information after the tile changes may also be used for driving decision-making. In other words, the tile may be updated, or the tile may not be updated.

In a possible implementation, the vehicle selects, from the changed tile, a tile that satisfies confidence information requirement as the reference tile for driving decision-making.

According to the foregoing method, the vehicle may select, from the changed tile, the tile that satisfies the confidence information requirement as the reference tile for driving decision-making, so that the vehicle selects the reference tile that satisfies the confidence information requirement and that can be used for driving decision-making. In this way, the vehicle may also use the reference tile when the map is not updated to a latest version, thereby ensuring safety of driving decision-making corresponding to driving of the vehicle.

In a possible implementation, the information about the confidence includes information about a similarity of the changed tile before and after the update.

In this implementation, the server may determine, based on the tile before the update, for example, the tile stored on the vehicle, and the tile after the update, that is, the changed tile of the map, information about a similarity between the changed tile of the map and the tile stored on the vehicle, to determine the information about the confidence of the changed tile. In this way, the vehicle may evaluate, based on the information about the confidence, the tile stored on the vehicle for driving decision-making, and provide, without updating a tile, related information of the map for driving decision-making for the vehicle, to satisfy a driving safety requirement of the vehicle.

In a possible implementation, the vehicle may further determine the information about the similarity between the changed tile of the map and the tile stored on the vehicle; determine information about confidence of a tile of the map based on information about a similarity between a to-be-updated tile and the tile stored on the vehicle; and perform driving decision-making based on the information about the confidence of the tile of the map and the tile stored on the vehicle.

In this implementation, the vehicle may determine, based on information about the tile before the update, for example, the tile stored on the vehicle, and the tile after the update, that is, information about the changed tile of the map, the information about the similarity between the changed tile of the map and the tile stored on the vehicle, to determine the information about the confidence of the changed tile. In this way, the vehicle may evaluate, based on the information about the confidence, the tile stored on the vehicle for driving decision-making, to satisfy a driving safety requirement of the vehicle without updating a tile.

In a possible implementation, the vehicle may obtain a pinpointed location of the vehicle and a navigation path of the vehicle; determine, based on the pinpointed location and the navigation path, a tile at which the vehicle is about to arrive; and select, from the changed tile, a tile that satisfies confidence information requirement and at which the vehicle is about to arrive, to be the reference tile for driving decision-making.

According to the foregoing method, the vehicle may further determine, based on the pinpointed location of the vehicle and the navigation path of the vehicle, a tile to be preferentially used by the vehicle. This effectively helps a user to find an updated map data package in a process of starting the vehicle or driving the vehicle, and when a corresponding tile is not downloaded, the tile that satisfies the confidence information requirement and at which the vehicle is about to arrive is preferentially used. In this way, a corresponding driving decision-making function can be used smoothly, to better assist navigation or autonomous driving.

In a possible implementation, the reference tile is downloaded from the server, and the map is updated based on the downloaded reference tile.

According to the foregoing method, the server may further deliver the reference tile to the vehicle, so that the vehicle updates the corresponding reference tile, to use data in the updated map data package in time and download a corresponding to-be-updated tile in time. In this way, the corresponding driving decision-making function can be used smoothly, to better assist navigation or autonomous driving.

In a possible implementation, the vehicle may further send a request for obtaining the reference tile to the server. For example, the request for obtaining the reference tile further includes an order of downloading, or a priority of downloading, the reference tile. According to the foregoing method, after determining the reference tile, the vehicle may further send the request for obtaining the reference tile to the server, to obtain the reference tile, thereby improving flexibility of obtaining the reference tile for the vehicle.

In a possible implementation, the order of downloading the reference tile is determined based on at least one of the following information: a requirement of the driving decision-making on using the reference tile; a driving type of the vehicle; a data type of the reference tile; or the information about the confidence.

According to the foregoing method, the vehicle may further determine the order of downloading the reference tile. In this way, downloading of the reference tile can satisfy requirements in more scenarios. For example, with different data types of the reference tile, a tile that is more closely related to driving safety may be preferentially downloaded. When driving of the vehicle is autonomous driving, a tile related to autonomous driving is preferentially downloaded based on a requirement of autonomous driving. In this way, a driving requirement at a current moment is preferentially satisfied, so that an update of the map can adapt to driving of the vehicle.

In a possible implementation, an order of updating the reference tile is determined based on at least one of the following information:
the requirement of the driving decision-making on using the reference tile; the driving type of the vehicle; the data type of the reference tile; or the information about the confidence.

According to the foregoing method, the vehicle may further determine the order of updating the reference tile based on the foregoing information. For example, when the vehicle can download a large quantity of reference tiles, considering that it takes corresponding time for the vehicle to update the map, a reference tile that satisfies the foregoing information may be preferentially updated based on a driving requirement of the vehicle, so that an update of the map can adapt to driving of the vehicle.

In a possible implementation, the vehicle may further determine the information about the confidence of the tile of the map based on the information about the similarity between the to-be-updated tile and the tile stored on the vehicle; and construct, based on the information about the confidence of the tile of the map, an environment model used by the vehicle for driving decision-making.

According to the foregoing method, before performing driving decision-making, the vehicle may further construct, based on the information about the confidence, the environment model used by the vehicle for driving decision-making, to prepare for driving decision-making performed by the vehicle, thereby improving driving performance of the vehicle.

According to a fourth aspect, this application provides a map-based driving decision-making method, applied to a server or a module or chip, of a server, that can indicate a vehicle to use a corresponding driving decision-making function based on a map update. The method includes: generating tile update information of a map, where the tile update information indicates a changed tile of the map, and the tile update information includes information about confidence of the changed tile; and sending the tile update information to a vehicle.

According to the foregoing method, the server may send the tile update information of the map and the information about the confidence of the changed tile to the vehicle, so that the vehicle may select, based on the information about the confidence, a reference tile for driving decision-making. In this way, there is no need to download all tiles of the map, and there is no need to download all changed tiles of the map. In other words, driving decision-making may be performed when only a part of tiles are updated, to improve timeliness and accuracy of assisting driving decision-making based on map information.

Specifically, the information about the confidence may indicate an absolute reliability of map information after the tile changes. The vehicle preferentially selects and updates a tile of a high absolute reliability, and performs driving decision-making after the tile of a high absolute reliability has been updated, not after all changed tiles have been updated. In addition, the information about the confidence may alternatively indicate a relative similarity between the map information after the tile changes and map information before the tile changes. For example, if the relative similarity is low, it indicates that the map information before the tile changes is no longer suitable for being used as reference information for driving decision-making, and the vehicle needs to update the tile, and uses updated map information for driving decision-making; or if a relative similarity is high, it indicates that the map information before the tile changes may be used for driving decision-making, and the map information after the tile changes may also be used for driving decision-making. In other words, the tile may be updated, or the tile may not be updated.

In a possible implementation, the information about the confidence includes information about a similarity of the changed tile before and after the update.

In this implementation, the server may determine, based on the tile before the update, for example, the tile stored on the vehicle, and the tile after the update, that is, the changed tile of the map, information about a similarity between the changed tile of the map and the tile stored on the vehicle, to determine the information about the confidence of the changed tile. In this way, the vehicle may evaluate, based on the information about the confidence, the tile stored on the vehicle for driving decision-making, and provide, without updating a tile, related information of the map for driving decision-making for the vehicle, to satisfy a driving safety requirement of the vehicle.

In a possible implementation, the method further includes: obtaining information about a reference tile, where the reference tile is a part of tiles in the changed tile; and sending the reference tile to the vehicle, where the reference tile is the part of tiles in the changed tile.

According to the foregoing method, the server may further deliver the reference tile to the vehicle, so that the vehicle updates the corresponding reference tile, to use data in the updated map data package in time and download a corresponding to-be-updated tile in time. In this way, the corresponding driving decision-making function can be used smoothly, to better assist navigation or autonomous driving.

In a possible implementation, the server may obtain a pinpointed location of the vehicle and a navigation path of the vehicle; determine, based on the pinpointed location and the navigation path, a tile at which the vehicle is about to arrive; and select, from the changed tile, a tile that satisfies confidence information requirement and at which the vehicle is about to arrive, to be the reference tile for driving decision-making.

According to the foregoing method, the server may further determine, based on the pinpointed location of the vehicle and the navigation path of the vehicle, a tile to be preferentially used by the vehicle, so that the vehicle can preferentially use the tile that satisfies the confidence information requirement and at which the vehicle is about to arrive. In this way, the corresponding driving decision-making function can be used smoothly, to better assist navigation or autonomous driving.

In a possible implementation, the server receives a request, sent by the vehicle, for obtaining the reference tile. The request for obtaining the reference tile further includes an order of downloading, or a priority of downloading, the reference tile. According to the foregoing method, after determining the reference tile, the vehicle may further send the request for obtaining the reference tile to the server, to obtain the reference tile, thereby improving flexibility of obtaining the reference tile for the vehicle.

In a possible implementation, an order of sending the reference tile is determined based on at least one of the following information:
a requirement of the driving decision-making on using the reference tile; a driving type of the vehicle; a data type of the reference tile; or the information about the confidence.

In a possible implementation, the server may determine the order of downloading the reference tile based on at least one of the following information: the requirement of the driving decision-making on using the reference tile; the driving type of the vehicle; the data type of the reference tile; or information about a similarity between the reference tile and a tile stored on the vehicle.

According to the foregoing method, a manner of the server of sending the reference tile can more flexibly adapt to requirements in more scenarios. For example, with different data types of the reference tile, a tile that is more closely related to driving safety may be preferentially sent. When driving of the vehicle is autonomous driving, a tile related to autonomous driving is preferentially sent based on a requirement of autonomous driving. In this way, a requirement of driving the vehicle at a current moment is preferentially satisfied, so that an update of the map can adapt to driving of the vehicle.

In a possible implementation, the server may determine an order of updating the reference tile based on at least one of the following information: the requirement of the driving decision-making on using the reference tile; the driving type of the vehicle; the data type of the reference tile; or the information about the similarity between the reference tile and the tile stored on the vehicle.

According to the foregoing method, the server may determine the order of updating the reference tile based on a driving requirement of the vehicle. Optionally, the server may send the order of updating the reference tile, to instruct the vehicle to update the reference tile according to the order of updating. For example, when the vehicle can download a large quantity of reference tiles, considering that it takes corresponding time for the vehicle to update the map, a reference tile that satisfies the foregoing information may be preferentially updated based on the driving requirement of the vehicle, so that an update of the map can adapt to driving of the vehicle.

In a possible implementation, the server determines the information about the confidence of the tile of the map based on the information about the similarity between the reference tile and the tile stored on the vehicle; and construct, based on the information about the confidence of the tile of the map, an environment model used by the vehicle for driving decision-making.

According to the foregoing method, before performing driving decision-making, the vehicle may further construct, based on the information about the confidence, the environment model used by the vehicle for driving decision-making, to prepare for driving decision-making performed by the vehicle, thereby improving driving performance of the vehicle.

According to a fifth aspect, an embodiment of this application further provides a map update apparatus, including a unit or module configured to perform the steps in the first aspect. The map update apparatus may be a vehicle that has a map update function and a map-based driving decision-making function and that performs the method according to the first aspect, or may be a chip disposed on a vehicle. The map update apparatus includes a corresponding module, unit, or means for implementing the foregoing method. The module, unit, or means may be implemented by hardware, implemented by software, or implemented by hardware by executing corresponding software. The hardware or the software includes one or more modules or units corresponding to the foregoing function. Specifically, an obtaining module, a processing module, a downloading module, and a decision-making module may be included.

The obtaining module is configured to obtain tile update information of a map, where the tile update information indicates a changed tile of the map.

The processing module is configured to: determine a to-be-updated tile based on a pinpointed location of the vehicle, a navigation path of the vehicle, and the tile update information, where the to-be-updated tile is a part of tiles in the changed tile; and update the map based on the downloaded to-be-updated tile.

The downloading module is configured to download the to-be-updated tile from a server.

The decision-making module is configured to perform driving decision-making based on the updated map.

In a possible implementation, the processing module is configured to: determine, based on the pinpointed location and the navigation path, a tile at which the vehicle is about to arrive; and determine the to-be-updated tile based on the tile at which the vehicle is about to arrive and the changed tile.

In a possible implementation, the processing module is further configured to determine an order of downloading the to-be-updated tile based on at least one of the following information:
a requirement of the driving decision-making on using the to-be-updated tile; a driving type of the vehicle; a data type of the to-be-updated tile; or information about a similarity between the to-be-updated tile and a tile stored on the vehicle.

In a possible implementation, the processing module is further configured to determine an order of updating the to-be-updated tile based on at least one of the following information:
the requirement of the driving decision-making on using the to-be-updated tile; the driving type of the vehicle; the data type of the to-be-updated tile; or the information about the similarity between the to-be-updated tile and the tile stored on the vehicle.

According to a sixth aspect, an embodiment of this application further provides a map update apparatus, including a unit or module configured to perform the steps in the second aspect. The map update apparatus may be a server that has a map update function and that performs the method according to the second aspect, or may be a chip disposed in a server. For example, the server may be at least one of a map server or an OTA update server. The map update apparatus includes a corresponding module, unit, or means for implementing the foregoing method. The module, unit, or means may be implemented by hardware, implemented by software, or implemented by hardware by executing corresponding software. The hardware or the software includes one or more modules or units corresponding to the foregoing function. Specifically, an obtaining module, a processing module, and a sending module may be included.

The obtaining module is configured to obtain information about a to-be-updated tile, where the to-be-updated tile is a part of tiles in the changed tile.

The processing module is configured to: send tile update information of a map to a vehicle by using a sending module, where the tile update information indicates a changed tile of the map; and send the to-be-updated tile to the vehicle by using the sending module.

In a possible implementation, the obtaining module is configured to:
obtain a pinpointed location of the vehicle and a navigation path of the vehicle.

The processing module is configured to determine the to-be-updated tile based on the tile update information, the pinpointed location, and the navigation path.

In a possible implementation, the processing module is configured to: determine, based on the pinpointed location and the navigation path, a tile at which the vehicle is about to arrive; and determine the to-be-updated tile based on the tile at which the vehicle is about to arrive and the changed tile.

In a possible implementation, the processing module is further configured to determine an order of downloading the to-be-updated tile based on at least one of the following information:
a requirement of the driving decision-making on using the to-be-updated tile;
a driving type of the vehicle;
a data type of the to-be-updated tile; or
information about a similarity between the to-be-updated tile and a tile stored on the vehicle.

In a possible implementation, the processing module is further configured to determine an order of updating the to-be-updated tile based on at least one of the following information:
the requirement of the driving decision-making on using the to-be-updated tile;
the driving type of the vehicle;
the data type of the to-be-updated tile; or
the information about the similarity between the to-be-updated tile and the tile stored on the vehicle.

According to a seventh aspect, this application provides a map-based driving decision-making apparatus, including a unit or module configured to perform the steps in the third aspect. The map update apparatus may be a vehicle that performs the method according to the third aspect and that has a map update function and a map-based driving decision-making function, or may be a chip disposed on a vehicle. The map update apparatus includes a corresponding module, unit, or means for implementing the foregoing method. The module, unit, or means may be implemented by hardware, implemented by software, or implemented by hardware by executing corresponding software. The hardware or the software includes one or more modules or units corresponding to the foregoing function. Specifically, an obtaining module, a processing module, and a decision-making module may be included. Optionally, a downloading module and a map update module may be further included.

The obtaining module is configured to obtain tile update information of a map, where the tile update information indicates a changed tile of the map, and the tile update information includes information about confidence of the changed tile; and the driving decision-making module is configured to select, based on the information about the confidence, a part of tiles in the changed tile to be a reference tile for driving decision-making.

In a possible implementation, the information about the confidence includes information about a similarity of the changed tile before and after the update.

In a possible implementation, the driving decision-making module is configured to:
obtain a pinpointed location of the vehicle and a navigation path of the vehicle by using the obtaining module; determine, based on the pinpointed location and the navigation path, a tile at which the vehicle is about to arrive; and select, from the changed tile, a tile that satisfies confidence information requirement and at which the vehicle is about to arrive, to be the reference tile for driving decision-making.

In a possible implementation, the downloading module is configured to download the reference tile from a server; and the map update module is configured to update the map based on the downloaded reference tile.

According to an eighth aspect, an embodiment of this application further provides a map-based driving decision-making apparatus, including a unit or module configured to perform the steps in the fourth aspect. The map update apparatus may be a server that has a map update function and that performs the method according to the fourth aspect, or may be a chip disposed in a server. For example, the server may be at least one of a map server or an OTA update server. The map update apparatus includes a corresponding module, unit, or means for implementing the foregoing method. The module, unit, or means may be implemented by hardware, implemented by software, or implemented by hardware by executing corresponding software. The hardware or the software includes one or more modules or units corresponding to the foregoing function. Specifically, a generation module, a processing module, and a sending module may be included. Optionally, an obtaining module may be further included.

The generation module is configured to: generate tile update information of a map, where the tile update information indicates a changed tile of the map, and the tile update information includes information about confidence of the changed tile; and the processing module is configured to send the tile update information to a vehicle by using the sending module.

In a possible implementation, the information about the confidence includes information about a similarity of the changed tile before and after the update.

In a possible implementation, the obtaining module is configured to obtain information about a reference tile, where the reference tile is a part of tiles in the changed tile.

The processing module is configured to send the reference tile to the vehicle by using the sending module, where the reference tile is the part of tiles in the changed tile.

In a possible implementation, the obtaining module is configured to obtain a pinpointed location of the vehicle and a navigation path of the vehicle; and the processing module is configured to: determine, based on the pinpointed location and the navigation path, a tile at which the vehicle is about to arrive; and select, from the changed tile, a tile that satisfies confidence information requirement and at which the vehicle is about to arrive, to be the reference tile for driving decision-making.

According to a ninth aspect, this application provides a map update apparatus. The apparatus includes a processor, configured to implement the method according to the first aspect. The apparatus may be applied to a vehicle. For example, the map update apparatus is a vehicle or a chip disposed on a vehicle. Alternatively, the apparatus is a combined device or component, in an on-board apparatus on a vehicle, having a map update function; or a combined device or component or the like having a map update function. For example, a transceiver is implemented by using, for example, an antenna, a feeder, a codec, and the like on the vehicle. Alternatively, if the apparatus is the chip disposed on the vehicle, an interface circuit is, for example, a communications interface in the chip, and the communications interface is connected to a radio frequency transceiver component on the vehicles, to receive and send information by using the radio frequency transceiver component.

The apparatus may further include a memory, configured to store a program and instructions. The memory is coupled to the processor, and when executing the program instructions stored in the memory, the processor can implement the method according to the first aspect. The apparatus may further include an interface circuit. The interface circuit is used by the apparatus to communicate with another device. For example, the interface circuit may be a transceiver, a circuit, a bus, a module, or an interface circuit of another type.

According to a tenth aspect, this application provides a map update apparatus. The apparatus includes a processor, configured to implement the method according to the second aspect. The apparatus may be applied to a server. For example, the server may be at least one of a map server or an OTA update server. For example, the map update apparatus is a server or a chip disposed in a server. For example, a transceiver is implemented by using, for example, an antenna, a feeder, a codec, and the like in the server. Alternatively, if the apparatus is the chip disposed in the server, an interface circuit is, for example, a communications interface in the chip, and the communications interface is connected to a radio frequency transceiver component in the server, to receive and send information by using the radio frequency transceiver component. The apparatus may be further applied to a road side device. For example, the road side device includes a road side unit and a map update apparatus in the road side unit. The map update apparatus may be a road side unit, may be a chip applied to a road side unit, may be a map update apparatus in a road side unit, or may be a chip applied to a map update apparatus in a road side unit, or the like.

The apparatus may further include a memory, configured to store a program and instructions. The memory is coupled to the processor, and when executing the program instructions stored in the memory, the processor can implement the method according to the second aspect. The apparatus may further include an interface circuit. The interface circuit is used by the apparatus to communicate with another device. For example, the interface circuit may be a transceiver, a circuit, a bus, a module, or an interface circuit of another type.

According to an eleventh aspect, this application provides a map-based driving decision-making apparatus. The apparatus includes a processor, configured to implement the method according to the third aspect. The apparatus may be applied to a vehicle. For example, the map-based driving decision-making apparatus is a vehicle or a chip disposed on a vehicle. Alternatively, the apparatus is a combined device or component, in an on-board apparatus on a vehicle, having a map-based driving decision-making function; or a combined device or component or the like having a map-based driving decision-making function. For example, a transceiver is implemented by using, for example, an antenna, a feeder, a codec, and the like on the vehicle. Alternatively, if the apparatus is the chip disposed on the vehicle, an interface circuit is, for example, a communications interface in the chip, and the communications interface is connected to a radio frequency transceiver component on the vehicles, to receive and send information by using the radio frequency transceiver component.

The apparatus may further include a memory, configured to store a program and instructions. The memory is coupled to the processor, and when executing the program instructions stored in the memory, the processor can implement the method according to the third aspect. The apparatus may further include an interface circuit. The interface circuit is used by the apparatus to communicate with another device. For example, the interface circuit may be a transceiver, a circuit, a bus, a module, or an interface circuit of another type.

According to a twelfth aspect, this application provides a map-based driving decision-making apparatus. The apparatus includes a processor, configured to implement the method according to the fourth aspect. The apparatus may be applied to a server. For example, the server may be at least one of a map server or an OTA update server. For example, the apparatus is a server or a chip disposed in a server. For example, a transceiver is implemented by using, for example, an antenna, a feeder, a codec, and the like in the server. Alternatively, if the apparatus is the chip disposed in the server, an interface circuit is, for example, a communications interface in the chip, and the communications interface is connected to a radio frequency transceiver component in the server, to receive and send information by using the radio frequency transceiver component. The apparatus may be further applied to a road side device. For example, the road side device includes a road side unit and a map-based driving decision-making apparatus in the road side unit. The apparatus may be a road side unit, may be a chip applied to a road side unit, may be a map-based driving decision-making apparatus in a road side unit, or may be a chip applied to a map-based driving decision-making apparatus in a road side unit, or the like.

The apparatus may further include a memory, configured to store a program and instructions. The memory is coupled to the processor, and when executing the program instructions stored in the memory, the processor can implement the method according to the fourth aspect. The apparatus may further include an interface circuit. The interface circuit is used by the apparatus to communicate with another device. For example, the interface circuit may be a transceiver, a circuit, a bus, a module, or an interface circuit of another type.

According to a thirteenth aspect, an embodiment of this application further provides a computer program. When the computer program runs on a computer, the computer is enabled to perform the possible methods according to any one of the first aspect to the fourth aspect.

According to a fourteenth aspect, an embodiment of this application further provides a computer storage medium. The computer storage medium stores a computer program, and when the computer program is executed by a computer, the computer is enabled to perform the possible methods according to any one of the first aspect to the fourth aspect.

According to a fifteenth aspect, an embodiment of this application further provides a chip. The chip is configured to read a computer program stored in a memory, to perform the possible methods according to the first aspect to the fourth aspect. The chip may be coupled to a memory.

According to a sixteenth aspect, an embodiment of this application further provides a chip system. The chip system includes a processor, configured to support a computer apparatus in implementing the possible methods according to any one of the first aspect to the fourth aspect. In a possible design, the chip system further includes a memory, and the memory is configured to store a program and data needed by the computer apparatus. The chip system may include a chip, or may include a chip and another discrete device.

According to a seventeenth aspect, an embodiment of this application further provides a map update system, including a user interface and the corresponding map update apparatus according to the fifth aspect or the ninth aspect and the corresponding map update apparatus according to the sixth aspect or the tenth aspect.

According to an eighteenth aspect, an embodiment of this application further provides a map-based driving decision-making system, including a user interface and the corresponding map-based driving decision-making apparatus according to the seventh aspect or the eleventh aspect and the corresponding map-based driving decision-making apparatus according to the eighth aspect or the twelfth aspect.

For technical effects achieved according to the fifth aspect to the eighteenth aspect or the possible implementations, refer to the descriptions of technical effects achieved according to corresponding implementations of the first aspect to the fourth aspect.

### BRIEF DESCRIPTION OF DRAWINGS

FIG. 1 is a schematic diagram of a scenario to which an embodiment of this application is applicable;

FIG. 2a is a schematic diagram of an architecture of a vehicle with a map update according to an embodiment of this application;

FIG. 2b is a schematic diagram of a map according to an embodiment of this application;

FIG. 3a to FIG. 3e are schematic diagrams of a map update;

FIG. 4 is a schematic flowchart of a map update method according to an embodiment of this application;

FIG. 5 is a schematic flowchart of a map update method according to an embodiment of this application;

FIG. 6a to FIG. 6d are schematic diagrams of a map update according to an embodiment of this application;

FIG. 7 is a schematic flowchart of a map-based driving decision-making method according to an embodiment of this application;

FIG. 8 is a schematic flowchart of a map-based driving decision-making method according to an embodiment of this application;

FIG. 9 is a schematic flowchart of a map-based driving decision-making method according to an embodiment of this application;

FIG. 10 is a schematic diagram of a structure of a map update apparatus according to an embodiment of this application;

FIG. 11 is a schematic diagram of a structure of a map update apparatus according to an embodiment of this application;

FIG. 12 is a schematic diagram of a structure of a map-based driving decision-making apparatus according to an embodiment of this application;

FIG. 13 is a schematic diagram of a structure of a map-based driving decision-making apparatus according to an embodiment of this application;

FIG. 14 is a schematic diagram of a structure of a map update apparatus according to an embodiment of this application; and

FIG. 15 is a schematic diagram of a structure of a map-based driving decision-making apparatus according to an embodiment of this application.

### DESCRIPTION OF EMBODIMENTS

Embodiments of this application are further described below with reference to the accompanying drawings.

An application scenario of embodiments of this application is described first. An embodiment of this application provides a map update method. A map updated according to the method may be applied to an autonomous driving system. A vehicle using the autonomous driving system may implement a transportation service based on a high-definition map. In this embodiment of this application, the transportation service may be various services in autonomous driving and assisted driving, for example, path planning and providing a driving risk warning during manual driving. The transportation services are merely examples. In the autonomous driving system, the high-definition map provided in this embodiment of this application may alternatively be a technical basis for vehicle to x (V2X) communications between the vehicle and another apparatus. The V2X includes, for example, vehicle to vehicle (V2V) communications or vehicle to infrastructure (V2I) communications.

The map update method provided in this embodiment of this application may be performed by a map update apparatus. The map update apparatus may be a terminal device, an on-board device, or a chip in a terminal device or an on-board device. The terminal device includes a hardware device that supports scientific computing, for example, may include a terminal device, for example, a personal computer, a server, a mobile phone terminal, or an embedded device.

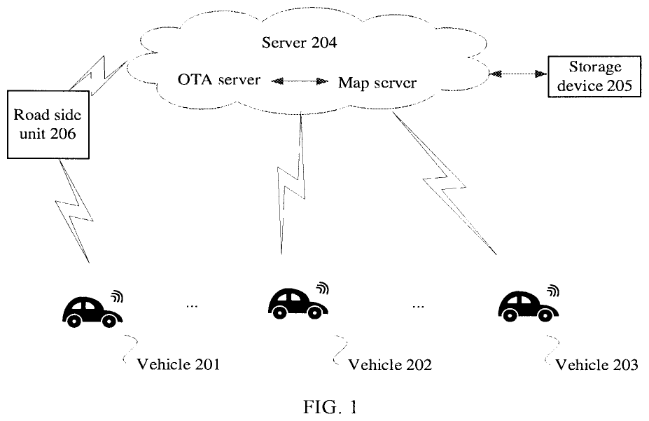

FIG. 1 shows a schematic diagram of an example of a scenario to which an embodiment of this application is applicable. As shown in FIG. 1, there may be one or more terminal devices and a server in the scenario, and one or more road side units may be further included. Optionally, a storage device and the like may be further included. Nouns or terms used in embodiments of this application are first described below with reference to FIG. 1.

(1) Terminal Device.

The terminal device in embodiments of this application may be a terminal device on a vehicle or a non-motor vehicle having a communications function, a portable device, a wearable device, a mobile phone (or referred to as a “cellular” phone), a portable, pocket-sized, or handheld terminal, or the like; or a chip in the devices, or the like. The terminal device in this application may be a terminal device applied to Internet of Vehicles, and the terminal device in this application may also be referred to as an Internet of Vehicles terminal device, an Internet of Vehicles terminal, an Internet of Vehicles communications apparatus, an on-board terminal device, or the like.

An example in which the terminal device is a vehicle is used in FIG. 1. As shown in FIG. 1, three vehicles are shown in FIG. 1, that is, a vehicle 201, a vehicle 202, and a vehicle 203. A vehicle is a typical terminal device in the Internet of Vehicles. In the following embodiments of this application, the vehicle is used as an example for description. Any vehicle in embodiments of this application may be an intelligent vehicle or a non-intelligent vehicle. This is not limited in embodiments of this application. A person skilled in the art should understand that, in this application, an embodiment in which a vehicle is used as an example may be further applied to another type of terminal device. Specifically, the terminal device may perform a service procedure related to the Internet of Vehicles by using an internal functional unit or apparatus of the terminal device. For example, when the terminal device is a vehicle, one or more of the following apparatuses on the vehicle may be configured to perform a procedure in a method related to the terminal device in embodiments of this application: for example, a telematics box (T-Box), a domain controller (DC), a multi-domain controller (MDC), an on-board unit (OBU), an Internet of Vehicles chip, and the like.

In embodiments of this application, the vehicle may communicate with another object by using a vehicle-to-everything (V2X) wireless communications technology. For example, a vehicle-to-vehicle (V2V) wireless communications technology may be used for communications between the vehicle and a cloud server. The vehicle and the another object may communicate with each other based on wireless fidelity (Wi-Fi), Bluetooth, a 5th generation (5G) mobile communications technology, or the like. For example, the vehicle and another apparatus (for example, a road side unit 206 or a server 204) may communicate with each other based on 5G.

In embodiments of this application, the terminal device may be configured to acquire information about a surrounding environment, for example, may acquire the information about the surrounding environment by using a sensor disposed on the terminal device. In embodiments of this application, the vehicle may include an information acquiring apparatus. The information acquiring apparatus may acquire original data by using a sensor. The information acquiring apparatus may further process the original data, to obtain processed data (for example, feature-level data or target-level data). When the terminal device is the vehicle, the information acquiring apparatus on the vehicle in this embodiment of this application may be a component in the vehicle, the vehicle, a mobile phone, or the like. The information acquiring apparatus may include an information acquiring apparatus in a positioning system of the vehicle, an information acquiring apparatus for intelligent driving, or any other device implementation that has a computing capability.

In this embodiment of this application, a sensor is disposed on the terminal device (for example, the vehicle). The sensor is configured to acquire information from near the vehicle. The sensor may include a camera, a laser radar, a millimeter-wave radar, an ultrasonic radar, a positioning apparatus (for example, a global navigation satellite system (GNSS) or an inertial measurement unit (IMU)). The GNSS may be used to estimate a geographic location of the vehicle. Therefore, the GNSS may include a transceiver that estimates a location of the vehicle relative to the earth based on satellite positioning data. In an example, a computer system of the vehicle may use the GNSS with reference to map data to estimate a road on which the vehicle moves. The IMU may sense changes of the location and an orientation of the vehicle based on an inertia, an acceleration, and any combination thereof. In some examples, a combination of sensors in the IMU may include, for example, an accelerometer and a gyroscope. Positioning information obtained by using the GNSS and information obtained by using another technology (for example, the IMU) are fused, and a fusion result is used as a global posture of the vehicle at a current moment. The manner of fusing, for positioning, the information obtained by using the GNSS and the information obtained by using another technology (for example, the IMU or another sensor) may be referred to as integrated positioning. Clearly, integrated positioning may further match data acquired by another sensor and data, from a corresponding sensor, stored in a map, to obtain a current lane-level pinpointed location of the vehicle. For example, the millimeter-wave radar sensor may use a radio signal to sense a target in a surrounding environment of the vehicle. In some embodiments, in addition to sensing the target, the millimeter-wave radar may be further configured to sense a speed and/or a moving direction of the target. The laser radar may use laser light to sense a target in an environment in which the vehicle is located. The camera sensor may be configured to capture a plurality of images from the surrounding environment of the vehicle. In addition, one or more types of sensors may be disposed on each vehicle, and there may be one or more sensors of each type. The sensor may be mounted at a position, for example, the top of the vehicle (for example, may be disposed in the middle at the top of the vehicle) or a front part of the vehicle. In this embodiment of this application, a position of each sensor and a quantity of sensors mounted on the vehicle are not limited.

(2) Road Side Unit 206.

As shown in FIG. 1, the RSU 206 may be included in the application scenario. The RSU 206 may be configured to send a vehicle-to-everything (V2X) message to a terminal device in a communications mode, for example, of direct communications (for example, PC5) or of a dedicated short range communications (DSRC) technology. The V2X message may carry dynamic information or other information of which the terminal device needs to be notified. A communications mode used by the road side unit and the terminal device may al so be referred to as vehicle to infrastructure (V2I) communications. It should be noted that FIG. 1 shows only paths for communications of the road side unit 206 with the vehicle 201 and the server 204. In actual application, the road side unit 206 may further have a path for communications, not shown in the figure, with another vehicle, for example, the vehicle 202 or the vehicle 203.

A specific form of deploying the road side unit is not specifically limited in this application. The road side unit may be a terminal device, a mobile or non-mobile terminal device, a server, a chip, or the like. The road side unit may be further configured to report dynamic information within an area of responsibility to an Internet of Vehicles server, for example, report the dynamic information by using a roadside information (RSI) message.

A system architecture to which embodiments of this application are applicable may include the road side unit, or may not include the road side unit. This is not limited in embodiments of this application. In a possible implementation, the road side unit may pay special attention to perception of some specified elements according to an instruction delivered by the server, and report a perception result. Alternatively, in another possible implementation, the road side unit may send an instruction or deliver an updated map to the terminal device.

An information acquiring apparatus may be further disposed in the road side unit in embodiments of this application. The information acquiring apparatus may acquire data by using a sensor. The information acquiring apparatus may further process the data acquired by the sensor, to obtain processed data (for example, feature-level data or target-level data). For details, refer to the information acquiring apparatus on the vehicle.

(3) Server 204.

As shown in FIG. 1, the server 204 may be included in the application scenario. The server 204 may be an Internet of Vehicles platform or server that manages and provides a service for a terminal device and/or a road side unit and that includes an application server or a map cloud server providing a service for a high-definition map and a navigation map or that may include an OTA server for updating a vehicle. In a possible implementation, the server 204 may be configured to update and deliver a map, for example, implement a function of updating a map used by a vehicle and a road side unit or the like. A specific form of deploying the server is not limited in this application. For example, the server may be deployed on the cloud, or may be a standalone computer device, chip, or the like. When a V2X message needs to be sent to the terminal device, the server may send the V2X message to the road side unit, and the road side unit broadcasts the message to the terminal device within a coverage area of the road side unit. Clearly, the server may directly send the V2X message to the terminal device.

In this application, the server may be an update server, and is a third-party device that can store an update file of a map and provide an update file downloading service for the terminal device. Optionally, the update server may be an OTA server, a cloud server, or the like.

The OTA server (also referred to as OTA cloud) is a cloud service provided by an automobile manufacturer or a service provider and is responsible for managing an update task and a software update package on the cloud, and delivering, in an OTA communications mode (for example, in a wireless communications mode, for example, Wi-Fi, a satellite, a cellular network, or a satellite, or in a wired transmission mode), the update task and the software update package to a vehicle that needs an update.

OTA provides a technical means to remotely update software of a vehicle or repair software bugs of the vehicle. With the development of autonomous driving, at present, the market has an increasingly high requirement on computing and control capabilities of a vehicle. An increasing quantity of vehicle functions are provided in a form of software, and software-defined vehicles are becoming an important trend for developing vehicles. A software-defined vehicle requires a vehicle to be able to easily install and update software like a computer or a smartphone, so that the vehicle “can be used for a long time and remains new”. A user may use an OTA technology to connect to the OTA cloud to download and install software. This reduces time and space limitations on updating vehicle software, with no inconvenience caused by conventional vehicle software updating that requires the user to drive a vehicle to a 4S store or a maintenance site and requires professional technicians to refresh the software on the vehicle by using a special device. Therefore, OTA is applied to an increasing quantity of vehicles.

For example, when the software is map software, a map OTA server may be disposed correspondingly. As a cloud service provided by a map business, the map OTA server is responsible for managing the map software and high-definition map data on the cloud, and delivering, in an OTA mode, the map software and the high-definition map data to a user/vehicle that needs to be updated.

In some embodiments, the update server may establish a connection to a map generation apparatus, to obtain an update file generated by the map generation apparatus; and store the update file based on a corresponding version identifier. In addition, the update server may establish a connection to the terminal device, to obtain an updating requirement of the terminal device on the map and select a plurality of corresponding update files of the map based on the updating requirement; stitch and combine the selected plurality of update files; and send the update files to the terminal device, so that the terminal device can update the map.

(4) Storage Device 205.

As shown in FIG. 1, the storage device 205 may be further included in the application scenario. The storage device 205 may be configured to store data, for example, may store a map.

(5) Map.

The map is an electronic map that exists in a form of electronic data, and the map includes a large amount of information about interconnected road sections and other related information (for example, a level and a type of a road section).

A vector map, for example, an open source vector map, includes road-level information. The road-level information may provide navigation information for a user, to satisfy a navigation requirement of a path for driving. For example, the road-level information may include a quantity of lanes on a current road, speed limit information of the current road, and turning information.

A high-definition map includes the road-level information and lane-level information. The lane-level information indicates information about a lane in a road network environment, for example, a curvature of the lane, a direction of the lane, a central axis of the lane, a width of the lane, a marking line of the lane, a speed limit on the lane, lane segmentation, lane merging, and other information. In addition, conditions of lane lines (a dashed line, a solid line, a single line, and a double line) between lanes, colors of the lane lines (white and yellow), a median strip in a road, a material of the median strip, an arrow in the road, textual content, a location, and the like may be further included in the lane-level information.

(6) Map Element.

Map elements refer to some elements in a map, including, but not limited to, a road, a lane line, a signage, a ground marking, a signal light, a marking line of an area for driving, and the like. The road may include a guardrail, a curb, and the like. The signage includes various types such as a road sign, an indicative sign, and a height limit sign. The ground marking includes a traffic diversion marking, an entrance/exit marking, a speed limit marking, a time limit marking, and the like.

Embodiments of this application relate to type information of a map element. The map element may be classified, and each type of map element may be identified based on a type. The type information mentioned in this specification may be a type identifier. A rule of the classification is not limited. For example, road signs may be classified into one type, ground markings may be classified into one type, or the like.

In a possible implementation, embodiments of this application may be applied to a high-definition map. Generally, the high-definition map is an electronic map of higher definition and more data dimensions, with more map elements. The higher definition is embodied by, for example, centimeter-level element information included in the map.

(7) Map Layer.

Map data is managed and stored as files. Different versions of files represent freshness of high-definition map data. Therefore, it may be determined, based on a version identifier (for example, a version number or version information) of a map, whether there is a to-be-updated map.

Because there is diverse content in a map, different layers may be set based on different functions. An element in each of the layers may correspond to a function of the layer. Based on an update frequency, a map layer may be classified into a static layer and a dynamic layer.

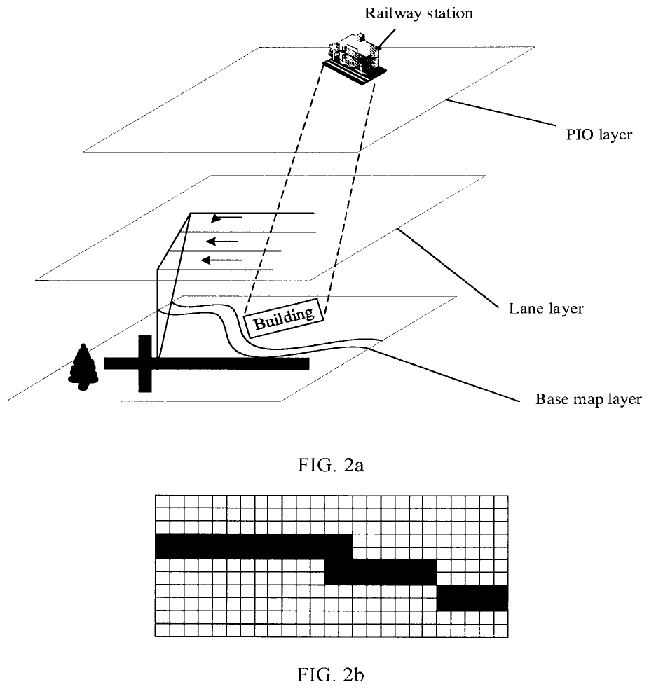

The static layer mainly refers to some target objects or objects, in a high-definition map, that have a low update frequency with no need to be frequently updated and that may include a road, a lane, a junction, a ground marking, road infrastructure, for example, a traffic sign, or a traffic signal light, and the like. For another example, road-level static layer information may include geometry of a road, a curvature of the road, a direction of the road, a speed limit on the road, a quantity of lanes, a longitudinal gradient, a transverse gradient, and other information. In some embodiments, as shown in FIG. 2a, a static layer may be a base map of a map, and the part includes a layer of most basic and most common map data elements. The map elements are, for example, a road, a river, a bridge, a green land, a building, or a contour of another surface feature. The base map may be overlaid with various layers, to satisfy a requirement of application. For example, as shown in FIG. 2a, a lane layer, a place of interest (POI) layer (for setting a point of interest, for example, a restaurant, a gas station, or another point of interest), and the like may be included. A road direction layer (for navigation and path planning), a road traffic jam condition layer, a satellite imagery layer, and another vector layer may be further included. The layers may further include a dynamic layer. The dynamic layer refers to a layer, in a high-definition map, that has a high update frequency. In some embodiments, information included in the dynamic layer may be information that may change during driving of a vehicle, for example, a changing traffic flow, a real-time road condition, road repairing, road closure, and other data that needs to be pushed or updated in real time. Therefore, for a map layer, a version identifier of the layer may be correspondingly set, to determine whether there is a to-be-updated map layer.

Map data, especially high-definition map data, is an important input for environment perception for an autonomous driving function. Accuracy and effectiveness of the map data are critical to driving safety in autonomous driving. Communications of an intelligent Internet-connected vehicle based on information in the dynamic layer can provide a more accurate basis for positioning, decision-making and planning, and perception fusion of the vehicle, thereby ensuring driving safety, comfort, and driving efficiency of a higher-level autonomous vehicle. However, a traffic environment changes with time. The high-definition map data, especially the information in the dynamic layer, is constantly changing, and data on different elements in different areas further changes differently. Therefore, data needs to be updated and ensured in time.

(8) Map Tile.

A high-definition map contains a large amount of data and is not easy to manage. To facilitate management and storage, the map may be segmented into different grids for management. In some embodiments, the map may be divided into regular grids of a same size. For example, as shown in FIG. 2b, the map may be divided into 25×11 grids of a same size. The size of each of the grid may be determined based on definition of the map, or may be determined in another manner. This is not limited herein. A map corresponding to each of the grids may also be referred to as a tile of the map.

When producing a map tile, map software (for example, the software ArcGIS) may be first used to process map data. Specifically, a map vector data item may be selected in a base map, and a tile of the base map is obtained by rendering through operations such as setting a color, setting a font, setting a display mode, and setting a display rule. Then, a layer in which the tile is located is determined based on a requirement. In this way, after the tile of the base map is overlaid with data of the corresponding layer, the map tile can be obtained.

To satisfy requirements on different resolutions, different tiles of the base map that have different resolutions may be further rendered. A description of any location in a tile of each map may be formed by using a plurality of layers of images that have different resolutions, for example, is formed by using 10 to 20 layers of images that have different resolutions. When a user zooms out the map, the user may select tiles that have different resolutions to form a complete map based on a scaling level.

With reference to a version of a map layer and a version of the map, a version identifier of a tile may be further correspondingly set. The version identifier may be a version identifier based on different layers, or may be a version identifier based on all layers on the tile. In this way, whether there is a to-be-updated tile may be determined based on the version identifier of the tile. The to-be-updated tile may mean that at least one layer on the tile is updated, that is, a corresponding to-be-updated tile is generated.

(9) Environment Model for Autonomous Driving.

In this application, when a vehicle uses an autonomous driving function, to better implement driving decision-making during autonomous driving, the vehicle or a map server may further construct an environment model corresponding to the autonomous driving function for the autonomous driving function of the vehicle. The environment model is used to support the vehicle in performing driving decision-making (for example, performing decision-making on vehicle speed control, acceleration, deceleration, emergency braking, a moving direction of the vehicle, a lane on which the vehicle moves, evasion, and a lane change) when the vehicle uses the autonomous driving function.

An example in which the vehicle constructs the environment model corresponding to the autonomous driving function is used below for description.

In some embodiments, a map module may construct, based on environment information (for example, road information, navigation information, road condition information, weather information, and other environment information) in a map tile, an environment element (for example, a road, a navigation path, a vehicle, a pedestrian, a road barrier, weather, and another environment element) in the environment model corresponding to the autonomous driving function.

For example, when a lane in the environment model corresponding to the autonomous driving function is constructed, the lane in the environment model corresponding to the autonomous driving function may be constructed based on lane information in the map tile.

In some embodiments, the map module may alternatively construct, based on environment information acquired by the vehicle, the environment element in the environment model corresponding to the autonomous driving function.

For example, when a lane in the environment model corresponding to the autonomous driving function is constructed, the lane in the environment model corresponding to the autonomous driving function may be constructed based on lane information acquired by a sensor on the vehicle. Alternatively, the lane in the environment model corresponding to the autonomous driving function may be constructed based on lane information acquired by a sensor on another vehicle.

Autonomous driving may be further classified into different levels. For example, the American Society of Automotive Engineers (SAE) defines different levels of autonomous driving. A fully autonomous driving mode may be L5, meaning that a vehicle completes all driving operations and a human driver does not need to keep attention. Partially autonomous driving modes may be L1, L2, L3, and L4. L1 means that a vehicle assists driving in one operation of using a steering wheel, accelerating, and decelerating, and a human driver is responsible for other driving operations. L2 means that a vehicle assists driving in a plurality of operations of using a steering wheel, accelerating, and decelerating, and a human driver is responsible for remaining driving actions. L3 means that a vehicle completes most driving operations, and a human driver needs to keep attention and be ready to take control. L4 means that a vehicle completes all driving operations, and a human driver does not need to keep attention, but there are limitations on a road and an environment condition. A manual driving mode may be L0, meaning that a vehicle is fully driven by a human driver.

Therefore, in this application, the environment model for autonomous driving may be further constructed based on different levels of autonomous driving, that is, environment models for different levels provide different environment information. For example, an environment model for a higher level of autonomous driving has more environment elements, or has environment information, of higher definition, corresponding to an environment element. In this way, requirements of different levels of autonomous driving are satisfied. Clearly, the environment element and the environment information that are used for the environment model for autonomous driving may be alternatively determined in another manner. This is not limited herein.

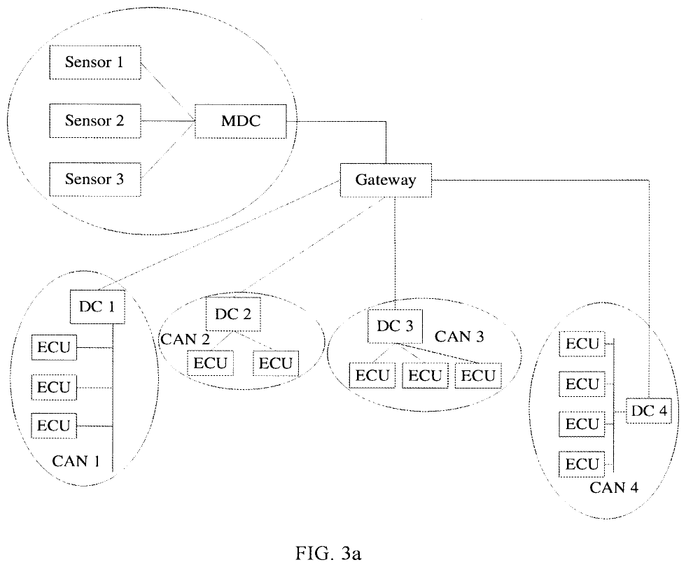

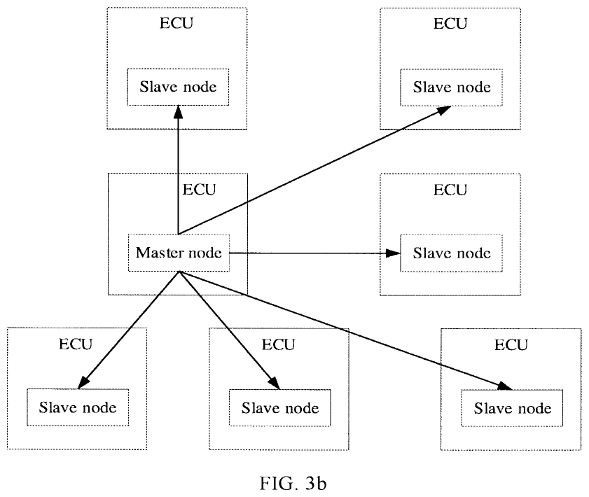

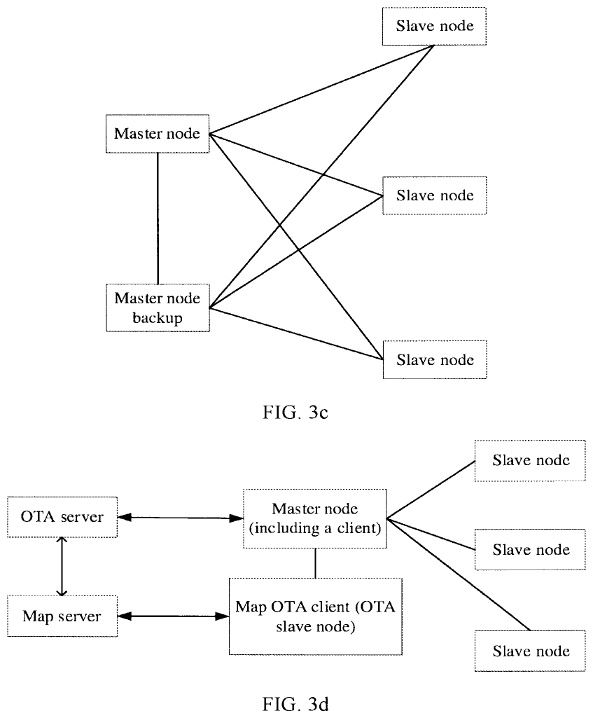

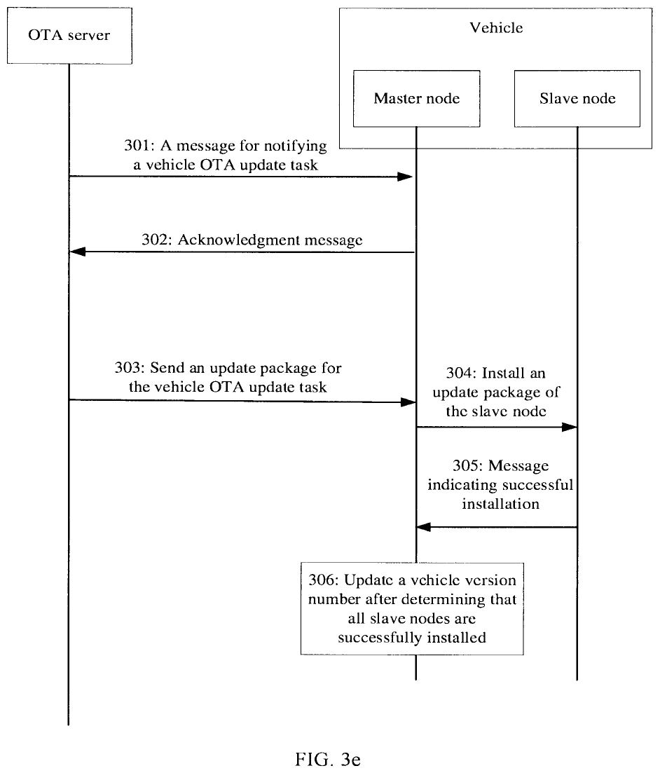

FIG. 3a is a schematic diagram of an architecture of all on-board devices or some on-board devices included on a vehicle. The on-board devices may be divided into several domains. Each of the domains includes one or more on-board devices, and each of the domains has a domain manager (DM). For example, an ADAS sensor forms one domain, and a domain manager of the domain is a mobile data center (MDC). In addition, FIG. 1 further includes four domain managers, that is, a DM 1, a DM 2, a DM 3, and a DM 4. The four domain managers correspond to four domains, and a device in each of the domains communicates with a gateway via the DM. A device type of each of the domain managers may be the same as a type of the device in the domain, or a device type of each of the domain managers is different from all types of devices in the domain. The on-board devices may be classified into a plurality of domains based on a plurality of classification factors. For example, the on-board devices may be classified based on functions implemented by the devices. For example, if several on-board devices are configured to cooperatively complete a specific function (for example, a power function), the on-board devices may be classified into one domain. Alternatively, different domains may be obtained through classification based on another factor. For a domain manager, for example, one on-board device in a domain is randomly selected as a domain manager, or an on-board device, in a domain, having a coordinated management function may be selected as a domain manager.

The on-board devices in the four domains in FIG. 3a are all, for example, ECUs. Each of the ECUs may complete a specific control or computing function by using software. OTA may mean that software updating is performed on a specific ECU on a vehicle. In this case, a software update package of the corresponding ECU may be downloaded from OTA cloud, and the software update package is installed by using the ECU for updating. Steps of vehicle OTA generally include steps such as notifying for updating, user permission, update package downloading, and updating execution.

To implement different functions, ECUs that have a plurality of different functions may be disposed on the vehicle. Usually, a complex function requires coordination of a plurality of ECUs. Therefore, the OTA may alternatively mean that software updating is performed on a plurality of ECUs on the vehicle. Considering that a function update with OTA varies greatly, for example, there is an update of a core function, an update of a non-core function, and the like, for ease of management, for updates of a plurality of ECUs, a maintained and updated version of the vehicle may be managed at a granularity of a vehicle, which is referred to as a vehicle OTA update. Each vehicle OTA update corresponds to an update of a vehicle version identifier. A vehicle OTA update task includes software updates of the plurality of ECUs on the vehicle. The update is marked as successful only when all functions are successfully updated.

The vehicle OTA update is usually related to the software updates of the plurality of ECUs, and the ECUs or updates of the ECUs have a specific codependent relationship on each other. Therefore, a centralized vehicle update control module may be disposed in the vehicle OTA task for coordinating the software updates of the plurality of ECUs. The vehicle update control module (update master) may be responsible for centralized control and coordination for the vehicle OTA update, and may also be referred to as a master node that may be deployed on a specific ECU in a form of software. An example in which a gateway is a master node is used in FIG. 3a. Actually, the master node is not limited to the gateway, and may alternatively be another on-board device, for example, may be a network management unit, a domain manager, an MDC, a core data center (CDC), or a T-Box.

As shown in FIG. 3b, in correspondence to a master node, a slave node (update slave) may be further deployed on a to-be-updated ECU on the vehicle, and the slave node may also be deployed on the to-be-updated ECU in a form of software. For a vehicle, generally, one master node and one or more slave nodes may be included. For a domain (or a set), in addition to a slave node, one or more on-board devices may be further included. In some embodiments, the master node may be used to control downloading and distribution of a vehicle update package. The master node downloads the vehicle update package from the OTA cloud, and splits and then distributes the package to corresponding slave nodes. When the master node determines that the software updates of the plurality of ECUs are all successful, the master node updates the vehicle version identifier and feeds the update back to the cloud, indicating that the vehicle OTA update is successful. Optionally, as shown in FIG. 3c, the vehicle may be further disposed with a backup module of the master node, so that when an ECU corresponding to the vehicle fails to be updated, an original version of the ECU can be restored by using the backup module of the master node, thereby avoiding that a function of the ECU corresponding to the vehicle cannot be used due to the update failure.

Correspondingly, a vehicle OTA client may be further deployed as a slave node on the to-be-updated ECU. For example, as shown in FIG. 3d, a map update client may be deployed on an ECU on which a map client is installed, or may be a part of a map client. During the vehicle OTA update, communications between the vehicle and a server may be implemented by using the master node and the vehicle OTA client. The server may include a map server and an OTA server. The map server may include a map server having an OTA function, or may include a server configured to manage and generate a map. The OTA server may include an OTA server corresponding to a map service, or may include an OTA server corresponding to a vehicle service provider. This is not limited herein. A deployment manner may be set based on an actual requirement. The master node and the vehicle OTA client may be disposed on a same ECU, or may be separately deployed. This is not limited herein. For example, the map update client may be deployed on the ECU on which the map client is installed, or may be a part of the map client; and is responsible for updating a map, including updating map data. In addition, the map update client may serve as a slave node for the vehicle OTA update.

In some other embodiments, a domain manager may alternatively be set to a slave node. The domain manager is connected to the master node (gateway), and is configured to receive a software update package delivered by the master node, and distribute, via the domain manager, a corresponding software update package to the to-be-updated ECU. For another example, during the vehicle OTA update, communications between the vehicle and the cloud may alternatively be completed by using a vehicle OTA proxy apparatus, and a function of the master node is implemented by using the proxy apparatus. As shown in FIG. 3e, specifically, the following steps are included.

Step 301: An OTA server obtains a vehicle OTA update task.

In some embodiments, the vehicle OTA update task of a to-be-updated vehicle may be distributed by an original equipment manufacturer (OEM), and a notification message for the vehicle OTA update task is sent to a vehicle or a terminal by using the OTA server. Alternatively, the vehicle OTA update task may be provided by another authorized service provider. This is not limited herein.

The notification message is used to notify the user of the current vehicle OTA update task for updating the vehicle, and the vehicle OTA update task may correspond to a vehicle version identifier.

Step 302: An acknowledgment message is sent to the OTA server in response to an operation of a user of acknowledging the notification message.

In some embodiments, the vehicle prompts the notification message to the user through human-machine interaction (HMI) of the vehicle. The notification message may be displayed on a display screen, or may be sent to the user by speech or in another manner. In response to the operation of the user of acknowledging the notification message, the terminal or the vehicle may determine that the user agrees to perform the vehicle OTA update task. The operation of acknowledging may be a voice-operated instruction, may be a gesture-operated instruction, or may be an instruction operated in another manner. This is not limited herein. Clearly, the terminal may further receive an operation of the user of declining or ignoring the notification message, to ignore the update task. Optionally, the user may be further notified of the update task again after a preset time, or the user may be notified of the update task again when an application related to the update task is executed. This is not limited herein. After the user selects for acknowledgment, in response to the operation of the user of acknowledging the notification message, the terminal or the vehicle may send the acknowledgment message to the OTA server, to perform the update task.

Step 303: After receiving the acknowledgment message, the OTA server sends an update package for the vehicle OTA update task.

Step 304: An OTA master node sequentially triggers a to-be-updated slave node to install an update package of the slave node.

The OTA master node in the vehicle downloads a vehicle update package and distributes the package to a plurality of slave nodes (to-be-updated ECUs).

For example, the slave node is a map ECU, and an update package of the map ECU may be used to update map data. In other words, an update of the map data may be used as a part of an update of the map ECU, and is completed together with an update of another ECU in a vehicle update.

In a possible implementation, a map data update solution may be as follows: One updated software update package is generated based on map data of a region (for example, a whole nation with data updated altogether, or an area divided based on a province or an urban area), so that high-definition map data is entirely updated as a part of the software update package. To speed up a map update, in another possible implementation, a map is divided into a plurality of tiles or areas. In a vehicle update, there may be no need to update the entire map, but to update a corresponding tile or area.

Step 305: After each of the slave nodes is successfully installed, a message indicating an installation success is sent to the master node.

Step 306: The master node updates the vehicle version identifier after determining that all to-be-updated slave nodes are updated.

OTA makes it easier to update software on a vehicle, but also brings extra risks. During software installation, an original software function cannot be used, and even normal driving of the vehicle may not be ensured, bringing unpredictable threats to safety of the vehicle and traffic safety. In addition, if an OTA update fails, the original function of the vehicle may become ineffective. As a result, the vehicle cannot be used, also bringing a safety hazard to the vehicle and traffic.

In a map update scenario, before an autonomous driving function is enabled, to ensure timeliness of map data, a map may need to be frequently updated. Because of a large amount of high-definition map data, with reference to the foregoing map update method, a map can be used only after an update package of a region is successfully updated or a plurality of tiles are all successfully updated, and it takes a long time for downloading. A user may need to wait for a long time for the update, update efficiency is limited, and there may even be an update failure. As a result, the user cannot use an updated map for a corresponding driving function, and user experience is poor. How to improve map data update efficiency and improve user experience is an important problem to be resolved.

### Embodiment 1

In view of the foregoing problem, this application provides a map update method. The method may be applied to a scenario shown in FIG. 1. A server and a terminal may be included in the scenario. For example, the terminal may be a to-be-updated vehicle. The server may include an OTA server that provides an update service for the vehicle and a map server that provides map information for the vehicle. It should be noted that, the OTA server and the map server may be separately deployed servers, or may be centrally deployed servers. This is not limited herein. The vehicle may be disposed with a map OTA client. The map OTA client may be disposed on an ECU related to a map, for example, disposed on an ECU corresponding to a navigation map module, or disposed on an ECU corresponding to a map module. This is not limited herein. In a possible scenario, the map OTA client may interact with the server, to update the ECU related to the map and update map data. In another possible scenario, map data may alternatively be updated by a vehicle OTA update. In this case, a vehicle end may include a master node and a slave node. An update of the map data may be a part of the vehicle OTA update. The map OTA client may serve as an OTA slave node and interact with a vehicle OTA master node. The vehicle OTA master node may interact with the server, to update the map-related ECU and update the map data.

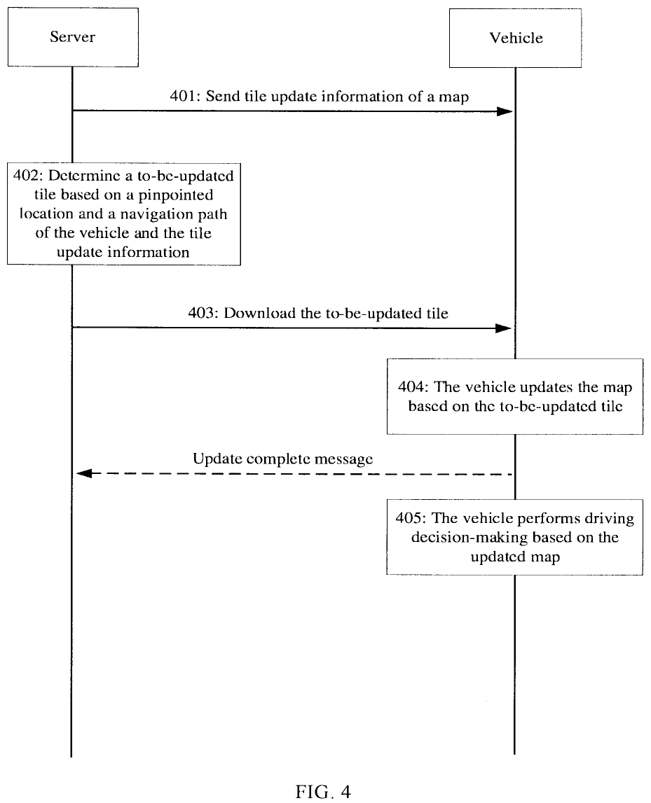

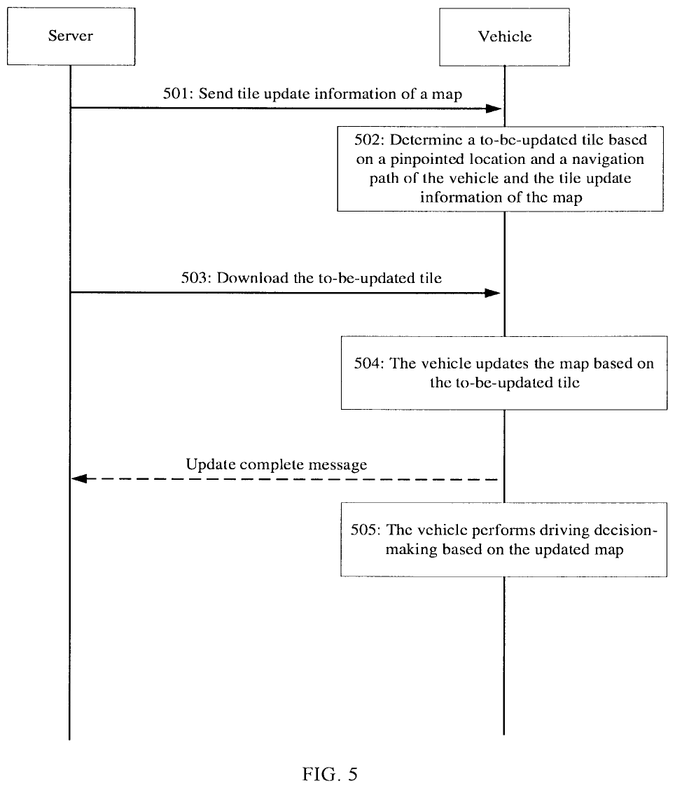

A method provided in an embodiment of this application is described below in detail with reference to a flowchart shown in FIG. 4, and includes the following steps.

Step 401: A server sends tile update information of a map to a vehicle.

Correspondingly, the vehicle obtains the tile update information of the map. The tile update information of the map indicates information about a changed tile of the map.

Step 4011 to step 4013 are used below as an example to describe how the vehicle obtains the information about the changed tile of the map.

Step 4011: The server determines information about a new map version, and generates a map data update task.

In some embodiments, a map server is configured to generate and determine the information about the new map version. For example, the information about the new map version may include at least one of the following: map data corresponding to the new map version, a map version identifier, a layer version identifier, a tile version identifier, and the like. After determining the information about the new map version, the map server may send the information about the new map version to an OTA server. Correspondingly, the OTA server may generate a map data OTA update task based on the information about the map version sent by the map server.

In some embodiments, the map server may update map data based on data acquired by the vehicle or a road side unit. For example, the vehicle may include an information acquiring apparatus. The information acquiring apparatus may acquire data by using a sensor, and transmits the data acquired by the sensor to the server or the road side unit. The information acquiring apparatus may further process original data, to obtain processed data (for example, feature-level data or target-level data); and transmit the processed data to the server or the road side unit. The server or the road side unit may generate an updated map and map version based on the data reported by the vehicle.

In some other embodiments, a map data update may alternatively be obtained from a department of transportation, a meteorological department, or the like. For example, some map data, for example, traffic jam information, traffic accident information, road condition information, traffic flow information, pedestrian or bicycle road crossing information, or pedestrian or motor vehicle road occupancy information of a lane; traffic jam information, traffic accident information, road condition information, traffic flow information, pedestrian or bicycle road crossing information, or pedestrian or motor vehicle road occupancy information of a road section; or weather information, may be dynamically updated. In this case, the server may generate an updated map and map version based on the data obtained from a related department.

Step 4012: The server sends an update notification message to the vehicle according to the map data update task.

The update notification message may be used to notify map information that can be updated or the information about the changed tile of the map. For example, the information about the changed tile of the map may include a version identifier of the changed tile of the map and corresponding updated descriptive information, so that the terminal determines whether the tile needs to be updated. For example, the update notification message may include the tile update information of the map, for example, a map version identifier, a tile version identifier, and a suitable vehicle type.

Optionally, the server may obtain a map version stored on the vehicle, to determine, through comparison between the map version currently stored on the vehicle and a version for the map data update task, whether the update notification message needs to be sent to the vehicle.

In some embodiments, the map server stores a historical map version and a latest map version, and the map server may send a request for querying about a map version to the vehicle. The request for querying may be used to obtain the map version currently stored on the vehicle, and the map version may include version identifiers of all tiles and a corresponding map version identifier. Alternatively, the map server may obtain the map version on the vehicle through a previous time of communications between the vehicle and the map server, for example, a previous time of a map update on the vehicle. In this way, the server may determine, through comparison between the map version currently stored on the vehicle and the version for the map data update task, whether the map version stored on the vehicle is the latest map version; and optionally, may further determine whether a version of a tile of a map is a latest version. When it is determined that a version of at least one tile needs to be updated, the update notification message may be sent to the vehicle, to notify the vehicle of a need to update the version of the at least one tile.

In some embodiments, the server may send the update notification message to the map OTA client on the vehicle. In some other embodiments, after determining that the vehicle has established a connection to the map server, the server may send the update notification message to the vehicle.

Optionally, the vehicle may query the server whether there is a map of a version newer than the map version stored on the vehicle, so that the server determines, through comparison between the map version currently stored on the vehicle and the version for the map data update task, whether the server needs to send the update notification message to the vehicle.

In some scenarios, the map client may be started as the vehicle is started. Alternatively, a terminal device associated with the vehicle logs in to a client of a manufacturer of the vehicle, or a user may start the map client on the terminal. The map client is associated with the vehicle, and may be a client used to query and manage whether a map on the vehicle needs to be updated. In this case, the client may establish a connection to the map server. After determining that the client is the client associated with the vehicle, the map server may send the update notification message to the client.

For another example, the client may alternatively send, to the server, a request message for querying whether the map is updated. The request message for querying may include a version identifier of the map version currently stored on the vehicle, an identifier of the vehicle, and the like. The server may send, based on the received request message for querying, the update notification message to the vehicle by using a response message for querying a map version.

Step 4013: The vehicle determines the information about the changed tile of the map based on the update notification message.

In some embodiments, the vehicle may mark, based on the information about the changed tile of the map in the notification message, a tile stored on the vehicle as the changed tile of the map, so that the vehicle subsequently manages the tile stored on the vehicle. For example, the vehicle may mark data on the tile stored on the vehicle corresponding to the changed tile of the map as unusable, or as an expired version, so that when invoking the map, the vehicle may determine that the data on the tile is an expired version, that is, the data on the tile is unusable, thereby avoiding a safety hazard because the vehicle wrongly invokes the data on the tile of the expired version.

Step 402: The vehicle determines a to-be-updated tile based on a pinpointed location of the vehicle, a navigation path of the vehicle, and the information about the changed tile of the map.

In a possible implementation, the vehicle determines a usage range of the map on the vehicle based on the pinpointed location and the navigation path of the vehicle, so that the vehicle determines the to-be-updated tile based on the usage range of the map and the information about the changed tile of the map. In some embodiments, the map OTA client on the vehicle may compare the information about the changed tile of the map determined in the update notification message with map data expected to be used by the vehicle (that is, map data corresponding to the usage range of the map), to determine the to-be-updated tile.

A manner A1 and a manner A2 are used as examples to describe how the vehicle determines the usage range of the map on the vehicle based on the pinpointed location and the navigation path of the vehicle.

In the manner A1, the usage range of the map may be determined based on an area of the map covered by a moving path of the vehicle.

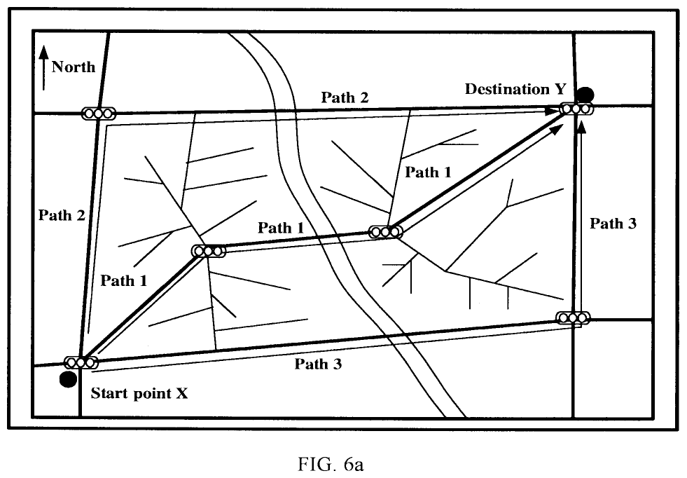

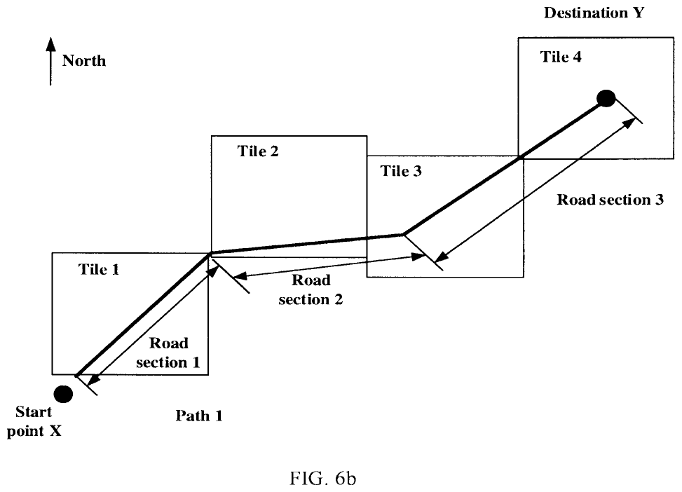

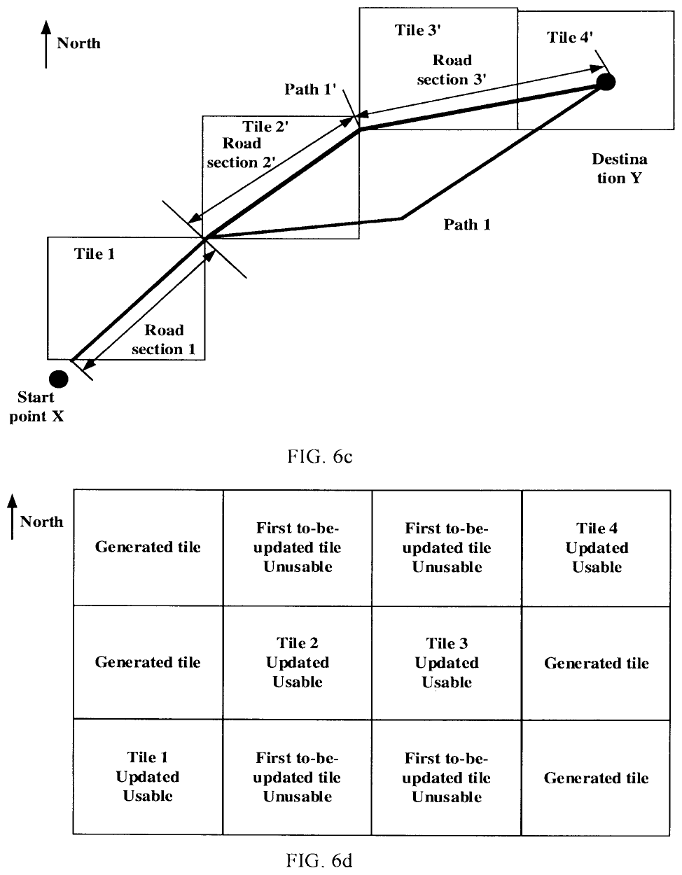

For example, the moving path of the vehicle may be determined in the following manner. As shown in FIG. 6a, a user needs to start from a point X and arrive at a destination point Y. In a specific implementation, the vehicle or the terminal may first display a destination input window in a user interface, and prompt the user to input the destination of the current trip. The user may be prompted to input the destination of the trip through a broadcast by using a loudspeaker or the like. After the user successfully inputs the destination of the trip in the user interface, the navigation map module on the vehicle acquires the destination input by the user, and plans, based on a current location of the user and the location of the obtained destination, at least one moving path from the current location of the user to the destination as an initial path. For example, refer to FIG. 4. After the user inputs the destination of the trip, the navigation map module may plan, based on the current location (that is, the start point X) of the user and the location (that is, the destination Y) of the obtained destination, three moving paths that can arrive at the destination Y. It is assumed that there are a path 1, a path 2, and a path 3. Herein, the path 1 is used as an example for description. A processing process for the path 2 and the path 3 is similar, and details are not described again.

In a possible implementation, the usage range of the map may be determined by the vehicle based on a tile related to the moving path. For example, as shown in FIG. 6b, the path 1 on a navigation map currently determined by the vehicle includes a road section 1, a road section 2, and a road section 3. Therefore, it may be determined that the usage range of the map is a range corresponding to a tile 1 in the road section 1, a tile 2 and a tile 3 in the road section 2, and the tile 3 and a tile 4 in the road section 3. Therefore, it may be determined that the current to-be-updated tile includes the tile 1, the tile 2, the tile 3, and the tile 4. Optionally, the to-be-updated tile may be marked as unusable, to-be-updated, or the like.

In still another possible implementation, the usage range of the map may correspond to an area occupied by a tile corresponding to the path 1 on the navigation map and a nearby tile. A specific related nearby range may be determined based on a requirement on definition for navigation. For example, when the requirement on definition for navigation is high, a small range may be selected, and correspondingly, a small quantity of tiles are selected. When the requirement on definition for navigation is high, a large range may be selected, and correspondingly, a large quantity of tiles are selected.

In the manner A2, the usage range of the map may be an area that corresponds to a tile at which the vehicle is about to arrive and that is determined based on the pinpointed location and the navigation path of the vehicle. A size of an area at which the vehicle is about to arrive may be a preset size.

For example, the vehicle may determine an area of the preset size based on the pinpointed location of the vehicle and a first navigation path. The area may be the area at which the vehicle is about to arrive. Therefore, the vehicle may use the area at which the vehicle is about to arrive as the usage range of the map. The area may be a conical area determined by using the pinpointed location of the vehicle as a center and the preset size as a radius, or a square area determined by using the pinpointed location of the vehicle as a center and the preset size as a diagonal, or a circular area determined by using the pinpointed location of the vehicle as a center and the preset size as a radius. The area may cover a part of the first navigation path. Clearly, the area may be determined in another manner. This is not limited herein. Alternatively, the vehicle may use an area in which a target vehicle is located and an adjacent area as the usage range of the map. For another example, the vehicle may use the area in which the target vehicle is located and an area of at least one tile in front of the area in which the target vehicle is located as the usage range of the map. Further, the usage range of the map may alternatively be determined based on a speed of the vehicle and complexity of an environment in which the vehicle is located. For example, to improve definition for navigation, if it is determined that information about a road condition for the vehicle is complex, the usage range of the map may be enlarged; or if it is determined that information about a road condition for the vehicle is simple, the usage range of the map may be narrowed.

When the vehicle determines that there are currently a plurality of paths that can be selected by the vehicle, a path selected by the user may be used as the navigation path. In this case, the vehicle may determine the usage range of the map based on the navigation path selected by the user, to determine the information about the to-be-updated tile.

Optionally, after determining the to-be-updated tile, the vehicle may further determine a strategy of updating the to-be-updated tile, so that the vehicle downloads/updates the to-be-updated tile according to the strategy of updating the to-be-updated tile.

The strategy of updating the to-be-updated tile may include at least one of the following: an order of downloading the to-be-updated tile, an order of updating the to-be-updated tile, a priority of downloading the to-be-updated tile, or a priority of updating the to-be-updated tile.

With reference to the manner A1, the vehicle may determine the moving path of the vehicle based on the pinpointed location and the navigation path of the vehicle, to determine, based on the moving path of the vehicle and the information about the to-be-updated tile, the order of downloading/updating the to-be-updated tile or the priority of downloading/updating the to-be-updated tile.

With reference to the manner A2, the vehicle may determine, based on the pinpointed location of the vehicle and the navigation path of the vehicle, the area at which the vehicle is about to arrive; and determine, based on the area at which the vehicle is about to arrive and the information about the changed tile of the map, the strategy of updating the to-be-updated tile.

For example, the first navigation path is the path 1. The tile 1 corresponding to the road section 1, the tile 2 and the tile 3 corresponding to the road section 2, and the tile 3 and the tile 4 corresponding to the road section 3 that are included on the path are first to-be-updated tiles. A strategy of updating the first to-be-updated tiles that may be set may be determined based on an order of using the map. For example, the tile 1 corresponding to the road section 1 is first used. In this case, a priority of updating the tile 1 is set to the highest. The tile 2 and the tile 3 corresponding to the road section 2 are then used. In this case, a priority of updating the tile 2 and the tile 3 is set to medium. The tile 3 and the tile 4 corresponding to the road section 3 are finally used. In this case, a priority of updating the tile 4 is set to the lowest. Optionally, the determined strategy of updating the first to-be-updated tiles includes that the priority of updating the tile 1 is the highest, the priority of updating the tile 2 and the tile 3 is medium, and the priority of updating the tile 4 is the lowest.

In another possible implementation, the vehicle may determine, based on the moving path of the vehicle, a driving type of the vehicle, and a data type of the first to-be-updated tiles, an order of downloading/updating the first to-be-updated tiles or a priority of downloading/updating the first to-be-updated tiles.

The driving type may be classified based on different types of autonomous driving. For example, the driving type may further include manual driving, autonomous driving, long-distance continuous autonomous driving, or the like. Alternatively, the classification may be performed based on different levels of autonomous driving, for example, based on L0 to L4. In this case, the vehicle may determine, based on different driving types and a data type of the first to-be-updated tiles, a first strategy of updating. For example, it is assumed that a current driving type corresponds to autonomous driving, and the data type of the first to-be-updated tiles is data corresponding to autonomous driving. In this case, the strategy of updating the first to-be-updated tiles that is determined based on the first navigation path may have a highest priority of downloading and a highest priority of installing, and the first to-be-updated tiles need to be installed before the vehicle moves, to satisfy a requirement of autonomous driving. For another example, it is assumed that in the first navigation path, a data type of a tile corresponding to 20% of the moving path is data type of autonomous driving, and the other part of the path has a data type of non-autonomous driving. In this case, a priority of the tile corresponding to the 20% of the moving path may be set to be the highest, and a priority of a tile corresponding to the other part of the path is correspondingly lower, to satisfy a requirement of an autonomous driving mode. Based on different driving types and different data types of the first to-be-updated tiles, different strategies of updating the first to-be-updated tiles may be set correspondingly, to adapt to the different driving types and updates of different maps, thereby further improving driving safety of the vehicle and flexibility of a map update.

In some embodiments, a priority of downloading may alternatively be set based on a current network condition. For example, when the network condition is good, a priority of downloading the first to-be-updated tiles in the usage range of the map may be set to the highest. A priority of downloading the changed tile of the map beyond the usage range of the map is lower. For another example, when the network condition is poor, it may be set that only the first to-be-updated tiles in the usage range of the map are downloaded, and downloading of the changed tile of the map beyond the usage range of the map is canceled. Optionally, a priority of a to-be-updated tile in the usage range of the map may be further set. For example, a priority of downloading the tile 1 is set to the highest, a priority of downloading the tile 2 and the tile 3 is set to medium, and a priority of downloading the tile 4 is set to the lowest.

In some other embodiments, a priority of updating may be set based on an environment and a requirement for the vehicle to update the to-be-updated tile. For example, it may be set that a tile, near the pinpointed location of the vehicle, that needs to be updated, for example, the tile 1, needs to be installed before the vehicle moves. It may be set that a to-be-updated tile that is far away from the pinpointed location of the vehicle is installed when the vehicle has moved to a place at a preset distance from a location, on the map, corresponding to the to-be-updated tile. The preset location may be determined based on a scenario in which the vehicle moves. For example, in a high-speed scenario, a suburban scenario, or a common road section scenario, the preset location may be determined based on a speed limit on a road, or a current moving speed of the vehicle and time for updating the to-be-updated tile. For another example, the to-be-updated tile that is far away from the pinpointed location of the vehicle may be determined based on a preset time point. For example, the to-be-updated tile may be installed at a preset time point before a predicted moment predicted by the navigation map at which the vehicle arrives at the to-be-updated tile. The preset time point may be a time point determined based on time from when the to-be-updated tile is updated to when the tile can be used, to improve a success rate of an update of the tile and use experience of map navigation.

Optionally, after it is determined that the to-be-updated tile is updated, the vehicle may further start to download/update the changed tile of the map, so that the vehicle may subsequently change the usage range of the map. When a corresponding tile needs to be used, the vehicle may not need to download/update the tile on-site, thereby improving user experience.

Clearly, in a process of downloading the changed tile of the map, a corresponding priority may be further set. For example, a path commonly used by the user may be determined based on historical data of the user on using the navigation map, to determine a common usage range of the map used by the user or the vehicle. In this way, a changed tile, of the map, to be preferentially updated is determined based on the common usage range of the map. After all changed tiles, of the map, to be preferentially updated are updated, another changed tile of the map may be started to be updated, until all changed tiles of the map are updated.

Step 403: The vehicle downloads the to-be-updated tile from the server.

In some embodiments, the vehicle may determine, according to the strategy of updating the to-be-updated tile, to download the to-be-updated tile. Optionally, the vehicle may send a request for obtaining the to-be-updated tile to the server. The server downloads tile data according to the received request for obtaining the to-be-updated tile.

For example, the vehicle may determine, according to an order of updating or a priority of updating the to-be-updated tile that is determined in the strategy of updating, the to-be-updated tile that is currently to be downloaded. With reference to FIG. 6b, the to-be-updated tile that is currently to be downloaded may be the tile 1. The to-be-updated tile may alternatively be the tile 1, the tile 2, and the tile 3, and the tile 1 has a highest priority.

In some other embodiments, the vehicle may alternatively send the strategy of updating the to-be-updated tile to the server, so that the server sends data of the to-be-updated tile to the vehicle according to the strategy of updating. For example, a message used by the vehicle for sending the strategy of updating the to-be-updated tile to the server may include the strategy of updating the to-be-updated tile, an identifier of the to-be-updated tile, the identifier of the vehicle, and the like. In this way, the server may send the data of the to-be-updated tile to the vehicle according to the strategy of updating the to-be-updated tile. In this case, the vehicle does not need to send the request for obtaining the to-be-updated tile to obtain the data of the to-be-updated tile each time the to-be-updated tile is updated.

In a possible implementation, a process of downloading a data package of the to-be-updated tile supports a resumable downloading mode. For example, the data package of the to-be-updated tile may be downloaded through fragment downloading, for example, downloaded by using a full package or a differential package. In some other embodiments, the server may speed up downloading by using a content delivery network (CDN) or in another manner. For example, the data package of the to-be-updated tile of the map may be alternatively downloaded in advance by using the road side unit. After the vehicle arrives at a communications range of the road side unit, the data package of the to-be-updated tile that is currently to be downloaded by the vehicle may be sent to the vehicle by using the road side unit. In this way, efficiency of the vehicle of downloading the to-be-updated tile is improved.

For example, a tile currently downloaded by the vehicle is the tile 1. After the vehicle arrives at a coverage area of a road side unit 1, the road side unit 1 may send a notification message to the server, to indicate the vehicle to arrive at the coverage area of the road side unit 1. In this case, the server may determine, based on whether the road side unit 1 stores a data package of the tile 1, whether the road side unit 1 sends data of the tile 1 to the vehicle. When the server determines that the road side unit 1 stores the data package of the tile 1, the server may send indication information to the road side unit 1. The indication information indicates the road side unit 1 to send the data of the tile 1 to the vehicle.

For another example, after the vehicle arrives at the coverage area of the road side unit 1, the vehicle may send a data downloading request to the road side unit 1. The data downloading request may include an identifier of the tile 1 and a version identifier of the tile 1. In this way, the road side unit 1 may determine, based on whether the road side unit 1 stores the data package of the tile 1, whether to send the data of the tile 1 to the vehicle. Clearly, to ensure data security, before the vehicle sends the downloading request, the road side unit 1 and the vehicle may verify each other, to ensure that each other can be reliable. Optionally, the vehicle and the road side unit 1 may further transmit the data of the tile 1 in a corresponding encryption manner. The encryption manner is not limited in this application.

Step 404: The vehicle updates the map based on the to-be-updated tile.

In some embodiments, the vehicle may update the map according to an order in which the to-be-updated tile is successfully downloaded.

In some other embodiments, the vehicle may install a downloaded tile according to the strategy of updating the to-be-updated tile.

For example, the map client (for example, the map OTA client) on the vehicle may install the downloaded tile based on an installation priority. Clearly, the to-be-updated tile may be installed according to an order in which downloading is completed. This may be determined based on a specific scenario and is not limited herein.

Optionally, when an update of each tile is completed, the vehicle displays an updated tile in a map display interface, or may notify, by using a notification message, the user of the completed update of the tile. In some embodiments, after determining that the update of the to-be-updated tile is completed, the vehicle may update the identifier of the tile to updated, usable, or the like. As shown in FIG. 6d, after it is determined that updates of the tile 1, the tile 2, the tile 3, and the tile 4 are completed, the tile 1, the tile 2, the tile 3, and the tile 4 may be marked as updated, or marked as usable. In this way, the vehicle may determine, based on whether a tile is usable, whether the corresponding tile can be invoked for driving the vehicle. For another example, an update progress of a tile may be alternatively displayed by using a progress bar. This is not limited herein.

Optionally, after determining that the update of the to-be-updated tile is completed, the vehicle sends an update complete message to the server.

The update complete message may include an identifier of the updated tile, the identifier of the vehicle, and the like.

Optionally, after completing a successful update of the map, the map OTA client may send, to the server, a message indicating that the map is updated, where the message indicating that the map is updated may be sent by using a log. The log may include time at which the map is updated, a status of the vehicle when the map is updated, an update result of the map, a map version after the map is updated, and other content.

According to the foregoing method, more update information of a tile is provided to indicate whether the tile is usable, that is, whether there is latest data, to improve an update success rate and user experience. A part of tiles in the changed tile of the map are selected to be the to-be-updated tile for an update, and an updated tile may be used in a process in which the vehicle uses the map for driving of the vehicle, thereby improving intelligent driving experience.

When the vehicle is moving, there may be further a scenario in which the navigation path needs to be switched, for example, from the first navigation path to a second navigation path. The vehicle may evaluate a strategy (the first strategy of updating) of updating a current to-be-updated tile (the first to-be-updated tiles) at any time, to determine whether the first strategy of updating the first to-be-updated tiles needs to be updated. For example, the first strategy of updating the first to-be-updated tiles is updated to a second strategy of updating a second to-be-updated tile.

For example, the vehicle determines, based on an updated tile, that the current navigation path includes an impassable or congested road. In this case, the vehicle may re-plan the navigation path based on the updated tile, and display the re-planned navigation path to the user, so that the user selects whether to switch the navigation path. Optionally, before the navigation path is re-planned, the user may be further prompted to decide whether the navigation path needs to be re-planned as there may be an impassable or congested road ahead.

In some embodiments, after the user switches the navigation path to the second navigation path, or after the vehicle determines to switch the navigation path to the second navigation path, the second to-be-updated tile determined based on a map area covered by the second navigation path of the vehicle and a second pinpointed location of the vehicle is the same as the first to-be-updated tiles. In this case, the vehicle may determine, based on the map area covered by the second navigation path after the switch and the second pinpointed location of the vehicle, the second strategy of updating the first to-be-updated tiles.

For example, the vehicle may obtain the second navigation path of the vehicle and the second pinpointed location of the vehicle; and determine the second to-be-updated tile based on the map area covered by the second navigation path of the vehicle and the second pinpointed location of the vehicle. Optionally, the second strategy of updating the second to-be-updated tile may alternatively be determined based on the map area covered by the second navigation path, the second pinpointed location of the vehicle, and information about the second to-be-updated tile.

For a specific manner of determining the second strategy of updating, refer to the manner of determining the first strategy of updating. Details are not described herein again.

For example, after the user switches the navigation path to the second navigation path, or after the vehicle determines to switch the navigation path to the second navigation path, the vehicle may re-determine the usage range of the map based on the second navigation path after the switch, to re-determine the to-be-updated tile and the corresponding second strategy of updating the to-be-updated tile.

For example, as shown in FIG. 6c, an original navigation path is a path 1 that includes the road section 1, the road section 2, and the road section 3. A navigation path after the switch is a path 1′ that includes a road section 1, a road section 2′, a road section 3′, and a road section 4′. The vehicle has arrived at an end of the road section 1 and is about to enter the road section 2 or the road section 2′. It may be re-determined, based on the navigation path after the switch, that a current usage range of the map includes a tile 2′ and a tile 3′ corresponding to the road section 2′, and a tile 4′ corresponding to the road section 3′. Therefore, it may be determined that the current to-be-updated tile includes the tile 2′, the tile 3′, and the tile 4′. In this case, an identifier of a tile that is in the determined to-be-updated tile on the path 1 and that is not yet updated may be changed to the changed tile of the map. In this way, an update of the tile is stopped, and the determined to-be-updated tile on the path 1 is preferentially updated. Therefore, when the vehicle is being used, navigation can be smoothly switched, without being affected by a map update that is not completed, and a problem that a corresponding function of the vehicle may not be implemented by using the map is not caused.

In some embodiments, after determining that the strategy of updating the tile is the second strategy of updating, the vehicle may further obtain data of the second to-be-updated tile. The second to-be-updated tile is determined according to the second strategy of updating. Therefore, the vehicle may update the map based on the data of the second to-be-updated tile.

In some embodiments, after determining that the strategy of updating the tile is the second strategy of updating, the vehicle may further send the second strategy of updating to the server. For example, the vehicle may send a message including an update of the strategy of updating the tile to the server. The message indicating the update may include the second strategy of updating, the identifier of the vehicle, and the identifier of the to-be-updated tile. Optionally, the message indicating the update may further include an identifier of an updated tile. In this way, the server may send the data of the second to-be-updated tile to the vehicle according to the second strategy of updating.

Step 405: Perform driving decision-making based on the updated map.

In a possible implementation, the vehicle may determine, based on the updated map, a driving decision that can be currently used by the map.

For example, the driving decision may include a driving mode of the vehicle, and the driving mode may be further divided based on different modes of autonomous driving, for example, may include modes such as manual driving, autonomous driving, and long-distance continuous autonomous driving. In this case, the vehicle may determine a suitable driving mode based on the updated map and the current navigation path. For example, it is assumed that all tiles on the current navigation path are updated tiles. In this case, a requirement of the autonomous driving mode is satisfied, and the vehicle may determine that a current driving mode can support the autonomous driving mode. It is assumed that tiles corresponding to only 20% of a road section on the navigation path satisfy the requirement of the autonomous driving mode. When selecting the current navigation path, the vehicle may use an automatic calculation mode in the 20% of the road section, and use another lower-level driving mode in another road section. For another example, if it is determined that a tile corresponding to a sub-path on the navigation path satisfies the requirement of the autonomous driving mode, the sub-path may be displayed to the user when the target vehicle arrives at a range of the sub-path, to prompt the user that there is the sub-path for selecting the autonomous driving mode. Different navigation path selection conditions may be correspondingly set for different driving modes, to adapt to different driving modes and further improve performance of navigation path planning.

A map update method provided in an embodiment of this application is described below with reference to a flowchart shown in FIG. 5. The method includes:

Step 501: A server sends tile update information of a map to a vehicle.

Correspondingly, the vehicle obtains the tile update information of the map. The tile update information of the map indicates information about a changed tile of the map.

Step 502: The server determines a to-be-updated tile based on a pinpointed location and a navigation path of the vehicle and the information about the changed tile of the map. The server may obtain, based on the pinpointed location and the navigation path that are reported by the vehicle, the pinpointed location of the vehicle and a map area covered by the navigation path, so that the server may determine the to-be-updated tile based on the pinpointed location of the vehicle, the map area covered by the navigation path, and the information about the changed tile of the map.

For a specific manner in which the server determines the to-be-updated tile, refer to the manner in which the vehicle determines the to-be-updated tile in step 402. Details are not described herein again.

Step 503: The vehicle downloads the to-be-updated tile from the server.

With reference to step 502, the to-be-updated tile may be determined by the server according to a strategy of updating. In this case, the server may send the to-be-updated tile to the vehicle according to a strategy of updating determined by the server, so that the vehicle downloads the to-be-updated tile from the server.

In a possible implementation, a process of downloading a data package of the to-be-updated tile supports a breakpoint downloading mode. For example, the data package of the to-be-updated tile may be downloaded by slices, for example, downloaded by using a full package or a differential package. In some other embodiments, the server may speed up downloading by using a content delivery network (CDN) or in another manner. For example, the data package of the to-be-updated tile of the map may be alternatively downloaded in advance by using the road side unit. After the vehicle arrives at a communications range of the road side unit, the data package of the to-be-updated tile that is currently to be downloaded by the vehicle may be sent to the vehicle by using the road side unit. In this way, efficiency of the vehicle of downloading the to-be-updated tile is improved.

Step 504: The vehicle updates the map based on the to-be-updated tile.

In some embodiments, the vehicle may update the map according to an order in which the to-be-updated tile is successfully downloaded.

In some other embodiments, the vehicle may install a downloaded tile according to the strategy of updating the to-be-updated tile.

For example, the map client (for example, the map OTA client) on the vehicle may install the downloaded tile based on an installation priority. Clearly, the to-be-updated tile may be installed according to an order in which downloading is completed. This may be determined based on a specific scenario and is not limited herein.

Step 505: Perform driving decision-making based on the updated map.

In a possible implementation, the vehicle may determine, based on the updated map, a driving decision that can be currently used by the map.

### Embodiment 2

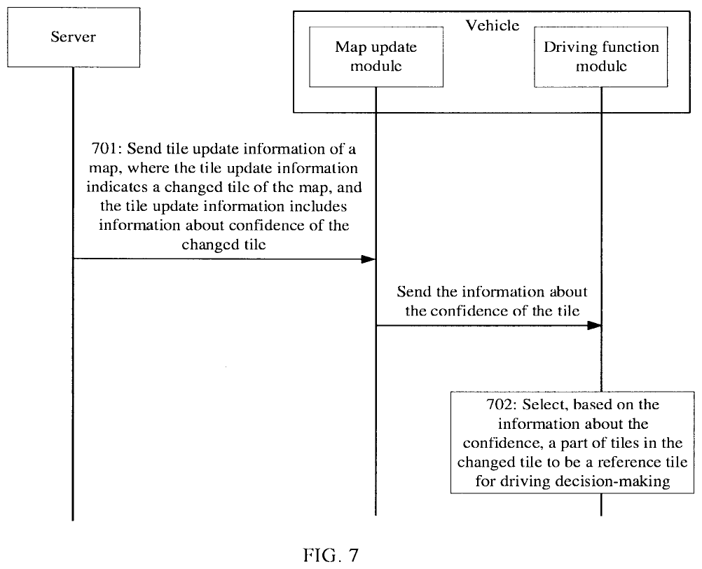

This application provides a map-based driving decision-making method. The method may be applied to a scenario shown in FIG. 1. A server and a terminal may be included in the scenario. For example, the terminal may be a to-be-updated vehicle. The server may include an OTA server that provides an update service for the vehicle and a map server that provides map information for the vehicle. It should be noted that, the OTA server and the map server may be separately deployed servers, or may be centrally deployed servers. This is not limited herein. The vehicle may be disposed with a map update module (for example, a map OTA client). The map OTA client may be disposed on an ECU related to a map, for example, disposed on an ECU corresponding to a navigation map module, or disposed on an ECU corresponding to a map module. This is not limited herein. In a possible scenario, the map OTA client may interact with the server, to update the ECU related to the map and update map data. In another possible scenario, map data may alternatively be updated by a vehicle OTA update. In this case, a vehicle end may include a master node and a slave node. An update of the map data may be a part of the vehicle OTA update. The map OTA client may serve as an OTA slave node and interact with a vehicle OTA master node. The vehicle OTA master node may interact with the server, to update the map-related ECU and update the map data. The method provided in this embodiment of this application is described below in detail with reference to a flowchart shown in FIG. 7. As shown in FIG. 7, the following steps are included.

Step 701: A server sends tile update information of a map to a vehicle.

Correspondingly, the vehicle obtains the tile update information of the map.

The tile update information indicates a changed tile of the map. In a possible implementation, the server sends the tile update information of the map to the map update module on the vehicle, so that the vehicle obtains the tile update information of the map. The tile update information of the map includes at least one of the following: information about a changed tile of the map, information about a similarity between the changed tile of the map and a tile locally stored on the vehicle, information about confidence of the tile locally stored on the vehicle, and information about confidence of the changed tile.

It should be noted that, the information about the confidence of the changed tile may be information about confidence of a tile, that corresponds to a latest version and that is stored on the server, relative to the tile locally stored on the vehicle.

In some embodiments, the information about the confidence of the changed tile may indicate an absolute reliability of map information after the tile changes. The vehicle preferentially selects and updates a tile of a high absolute reliability, and performs driving decision-making after the tile of a high absolute reliability has been updated, not after all changed tiles have been updated.

For example, the vehicle or the server may determine the information about the confidence of the changed tile based on the similarity information of the changed tile of the map. For example, when the confidence of the changed tile is high, it indicates that the changed tile needs to be preferentially used for driving decision-making. Therefore, the tile may be selected to be a reference tile, so that after obtaining data of the changed tile, the vehicle uses the changed tile to perform driving decision-making. When the confidence of the changed tile is low, it indicates that the changed tile does not need to be used for driving decision-making. Therefore, the vehicle may use data of the locally stored tile as a reference tile to perform driving decision-making. In this way, in a process of updating the map on the vehicle, the locally stored tile or the changed tile is selected, based on the information about the confidence of the tile, to be the reference tile for driving decision-making, so that flexibility of a map update and flexibility and safety of map-based driving decision-making are improved while a safety requirement is satisfied.

For another example, the vehicle or the server may alternatively determine the information about the confidence of the changed tile in another manner. For example, the vehicle or the server may determine the information based on content and a feature of the tile, a type of driving decision-making, and the like. In a layer, of the tile, with a greater safety coefficient, information about lower confidence may be set, and in a layer, of the tile, with a smaller safety coefficient, information about higher confidence may be set, so that the vehicle determines, based on the information about the confidence of the changing tile, whether to use the changing tile or use the locally stored tile for driving decision-making.

For a manner in which the vehicle obtains the information about the changed tile of the map, refer to step 401. Details are not described herein again.

There may be a plurality of manners in which the vehicle obtains the information about the similarity between the changed tile of the map and the tile stored on the vehicle. A manner B1 and a manner B2 are used below as examples for description.

In the manner B1, the vehicle may compare the information about the changed tile of the map with the tile stored on the vehicle, to determine the information about the similarity between the changed tile of the map and the tile stored on the vehicle.

In this embodiment of this application, a similarity between tiles is also referred to as a similarity measurement of the tiles, namely, a measurement for comprehensively evaluating a degree of similarity between two tiles. It can be understood that, the more similar the two tiles, the greater the similarity.

When determining that a version of the map on the vehicle needs to be updated, the vehicle may determine similarity information of a new map by comparing the version of the map on the vehicle with a version of the new map. Specifically, information about a similarity between each changed tile of the map and the tile on the vehicle may be determined. For example, the vehicle determines that the to-be-updated tile includes a tile 1, a tile 2, and a tile 3. A tile on the vehicle corresponding to the to-be-updated tile 1 may be a tile 01. The vehicle may determine information about a similarity between the tile 1 and the tile 01 based on the tile 1 and the tile 01. A tile on the vehicle corresponding to the to-be-updated tile 2 may be a tile 02. The vehicle may determine information about a similarity between the tile 2 and the tile 02 based on the tile 2 and the tile 02. A tile on the vehicle corresponding to the to-be-updated tile 3 may be a tile 03. The vehicle may determine information about a similarity between the tile 3 and the tile 03 based on the tile 3 and the tile 03.

In some other embodiments, the vehicle may further determine a corresponding similarity level based on different types of tiles. For example, content of a tile with a greater safety coefficient may correspond to a lower similarity level, and content of a tile with a smaller safety coefficient may correspond to a higher similarity level. For example, a type of a road element of a lane in a tile includes a curvature and a gradient of the lane, and current weather and data on traffic flow on each lane.

For another example, the vehicle may alternatively set similarities corresponding to different types of tiles, to help the vehicle to determine the information about the confidence of the tile, thereby better determining how to use the tile, and improving driving safety and reliability of the vehicle.

Optionally, to reduce a task load of updating the map on the vehicle, when determining that the information about the similarity is greater than a preset threshold, the vehicle may determine whether to update the tile.

In the manner B2, the server determines, based on the information about the changed tile of the map and the information about the tile stored on the vehicle, the information about the similarity between the changed tile of the map and the tile stored on the vehicle.

Optionally, the server may determine, based on the information about the similarity between the changed tile of the map and the tile stored on the vehicle, a task of updating the changed tile of the map. Therefore, the server sends the task of updating the tile to the vehicle. A manner in which the server sends the task of updating the tile may be that the task of updating the tile is sent by using the OTA server or is directly sent by the map server to the vehicle. This is not limited herein. For a specific manner of sending, refer to step 4012, and details are not described herein again. The task of updating the tile may include information about a version of the changed tile of the map, and the information about the similarity between the changed tile of the map and the tile stored on the vehicle.

In some embodiments, the map server may compare information about a version of the map on the vehicle with information about a version of a new map, to determine whether the map on the vehicle needs to be updated.

When determining that the version of the map on the vehicle needs to be updated, the map server may determine similarity information of the new map by comparing how similar the map on the vehicle is to the new map. Specifically, the information about the similarity between each changed tile of the map and the tile on the vehicle may be determined. For example, the map server determines that the changed tile of the map includes a tile 1, a tile 2, and a tile 3. A tile on the vehicle corresponding to the changed tile 1 of the map may be a tile 01. The map server may determine information about a similarity between the tile 1 and the tile 01 based on the tile 1 and the tile 01. A tile on the vehicle corresponding to the changed tile 2 of the map may be a tile 02. The map server may determine information about a similarity between the tile 2 and the tile 02 based on the tile 2 and the tile 02. A tile on the vehicle corresponding to the changed tile 3 of the map may be a tile 03. The map server may determine information about a similarity between the tile 3 and the tile 03 based on the tile 3 and the tile 03.

In some other embodiments, a corresponding similarity level may alternatively be determined based on different types of content of a tile. For example, content of a tile with a greater safety coefficient may correspond to a lower similarity level, and content of a tile with a smaller safety coefficient may correspond to a higher similarity level. For example, a type of a road element of a lane in a tile includes a curvature and a gradient of the lane, and current weather and data on traffic flow on each lane.

For example, the content included in the tile is a quantity of vehicles, and a similarity level correspondingly determined based on a quantity of lanes is low. When quantities of lanes are different, a similarity between tiles is low. When the quantities of lanes are the same, a level of a similarity between curvatures of the lanes may be correspondingly set to a high level. When the quantities of lanes are the same but the curvatures of the lanes are different, a similarity between the tiles may be higher than the similarity of the tiles obtained when the quantities of lanes are different. For another example, a level of a similarity between tiles corresponding to the gradient of the lane may be high.

For another example, similarities corresponding to different types of content of a tile may alternatively be set, to help the vehicle to determine the information about the confidence of the tile, thereby better determining how to use the tile, and improving driving safety and reliability of the vehicle.

Optionally, to reduce a task load of updating the map on the vehicle, when determining that the information about the similarity is greater than a preset threshold, the map server may generate a task of updating a tile for the corresponding tile. Alternatively, all changed tiles of the map and similarity information corresponding to the changed tile of the map may be included in the task of updating the changed tile of the map, and the vehicle determines, based on the similarity information in the task of updating the tile, whether to update the tile.

Optionally, the vehicle determines, based on the information about the similarity between the information about the changed tile of the map and the tile stored on the vehicle, the information about the confidence of the locally stored tile.

In some embodiments, the vehicle may determine the information about the confidence of the locally stored tile based on the similarity information of the changed tile of the map. The information about the confidence may be used to measure reliability of an identification result.

For example, the vehicle may determine, based on a similarity of the changed tile of the map according to a preset relationship between a similarity and information about confidence, the information about the confidence of the locally stored tile. For example, a relationship between a similarity and information about confidence may be a linear relationship, or may be a non-linear relationship. A greater similarity indicates information about higher confidence of the locally stored tile. In some other embodiments, a higher similarity may also indicate information about higher confidence of the locally stored tile, and correspondingly, information about lower confidence of the changed tile. In this case, the information about the confidence of the changed tile indicates an urgency degree of updating a map locally stored on the vehicle to the changed tile.

In some embodiments, a corresponding threshold may be further set. When the similarity is greater than the preset threshold, it may be determined that the information about the confidence of the locally stored tile is reliable, and the locally stored tile can be used for driving and a corresponding function of the vehicle. The relationship between a similarity and information about confidence may be determined based on content and a feature of a tile. For example, a determined layer corresponding to the tile is a layer with a greater safety coefficient that includes, for example, a tile in a layer, for example, of traffic information, weather information, and traffic flow information; or that is a layer for a lane update. In this case, a high similarity threshold may be set. To be specific, information about high confidence can be obtained only when the similarity exceeds the high threshold. For a map update in a layer with a smaller safety coefficient, for example, of buildings, that does not affect driving of the vehicle, a low similarity threshold may be set. In this case, information about high confidence may be obtained when similarity information of the tile exceeds the low similarity threshold.

There are a plurality of methods for calculating information about confidence, and at least the following several methods are included: Bayesian classification for directly obtaining a posterior probability, a neural network or another method for estimating the posterior probability, an algorithmic randomness theory for obtaining a randomness measurement, fuzzy mathematics for obtaining a value of a degree of membership, and a plurality of times of testing experiments for obtaining accuracy through statistics. It should be noted that, a method for calculating information about confidence in this embodiment of this application is not limited to the foregoing several methods. Any calculation method that can be used to determine information about confidence may be applied to this embodiment of this application, and shall fall within the protection scope of embodiments of this application. Optionally, the map update module on the vehicle sends the information about the confidence of the tile to a driving function module on the vehicle.

Step 702: The vehicle selects, based on the information about the confidence of the changed tile, a part of tiles in the changed tile to be a reference tile for driving decision-making.

The reference tile is a part of tiles in the changed tile.

In some embodiments, the vehicle may select, from the changed tile, a tile that satisfies confidence requirement as the reference tile for driving decision-making.

In some other embodiments, the vehicle may alternatively select, based on information about confidence of all tiles locally stored on the vehicle, a tile that satisfies a confidence requirement as the reference tile for driving decision-making.

Optionally, the driving function module on the vehicle may use a corresponding driving function of the vehicle based on the information about the confidence of the tile sent by the map update module on the vehicle to the driving function module on the vehicle.

In some embodiments, the driving function module on the vehicle may further construct, based on information about confidence of a tile, of the map, locally stored on the vehicle, an environment model corresponding to an autonomous driving function.

Optionally, the vehicle may further perform driving decision-making based on the information about the similarity between the changed tile of the map and the tile locally stored on the vehicle.

In a possible implementation, the map update module on the vehicle sends, to the driving function mode on the vehicle, the information about the similarity between the changed tile of the map and the tile locally stored on the vehicle, and the driving function module on the vehicle performs driving decision-making based on the information about the similarity between the changed tile of the map and the tile locally stored on the vehicle.

Driving decision-making may include that the vehicle uses the corresponding driving function of the vehicle, to control the vehicle.

Optionally, the driving function module on the vehicle may determine, based on the information about the similarity between the changed tile of the map and the tile locally stored on the vehicle, the information about the confidence of the tile locally stored on the vehicle, so that the driving function module on the vehicle uses the corresponding driving function of the vehicle based on the information about the confidence of the tile locally stored on the vehicle.

It should be noted that, the driving function module may construct the environment model corresponding to the autonomous driving function, an independent module for constructing the environment model may construct the environment model corresponding to the autonomous driving function based on the information about the confidence of the tile, or the map server may construct the environment model based on the information about the confidence of the tile. This is not limited herein. In this case, the map update module may send the information about the confidence of the tile to the module for constructing the environment model, so that the module for constructing the environment model may determine, based on the information about the confidence of the tile, a source of an environment element used for constructing the environment model for the autonomous driving function. For example, the environment element in the environment model corresponding to the autonomous driving function may be constructed based on a tile of a map, or the environment element in the environment model corresponding to the autonomous driving function may be constructed based on environment information acquired by the vehicle.

An example in which the driving function module constructs the environment model corresponding to the autonomous driving function is used below.

For example, when the autonomous driving function is enabled, the driving function module may determine, based on information about confidence of a tile of a map, the source of the environment element used for constructing the environment model for the autonomous driving function. For example, when the environment information (for example, a road or a road barrier) acquired by a sensor on the vehicle deviates from environment information in the tile of the map, it may be determined, based on the information about the confidence of the tile of the map, whether to use the environment information in the tile of the map or the environment information acquired by the vehicle.

When the information about the confidence of the tile of the map is greater than a selection threshold, the driving function module selects the environment information in the tile of the map, to construct the environment information in the environment model used for the autonomous driving function. When the information about the confidence of the tile of the map is less than the selection threshold, the environment information acquired by the vehicle is selected to construct the environment information in the environment model used for the autonomous driving function.

For example, a road in the environment model is constructed. When determining that information about confidence of a tile, of a map, indicating road information is greater than the selection threshold, the driving function module uses the road information in the tile of the map to construct the road in the environment model used for the autonomous driving function. When the information about the confidence of the tile of the map is less than the selection threshold, road information acquired by the vehicle is used to construct the road in the environment model used for the autonomous driving function.

It should be noted that the selection threshold may be determined based on a level of the autonomous driving function. For example, when the autonomous driving function is of a highest level, the selection threshold may be set to a highest threshold, to ensure that the constructed environment model can adapt to the corresponding level of the autonomous driving function.

In some other embodiments, when the driving function module determines that the vehicle cannot acquire the environment information to construct the environment element in the environment model corresponding to the autonomous driving function, or that the vehicle cannot obtain environment information acquired by another vehicle either, the driving function module may select to reduce a level of the autonomous driving function corresponding to the environment element, and construct the environment element by using a corresponding tile. To be specific, when the vehicle uses the environment element for autonomous driving, the driving function module may use the level of the autonomous driving function corresponding to the environment element.

According to the foregoing method, higher reliability of the constructed environment model for the autonomous driving function can better serve autonomous driving, thereby improving safety of autonomous driving.

For example, a driving function of the vehicle may correspond to a function related to autonomous driving of the vehicle. A program related to controlling autonomous driving of the vehicle may be a program for managing interaction between the autonomous vehicle and an obstacle on a road, a program for controlling a path or a speed of the autonomous vehicle, a program for controlling interaction between the autonomous vehicle and another autonomous vehicle on a road, or the like.

In some other embodiments, it is assumed that an updated tile may be used for a highest level of intelligent driving. In this case, the vehicle may further correspondingly set, based on information about confidence of the tile, a corresponding level of intelligent driving. That is, the information about the confidence may further indicate the level of intelligent driving corresponding to the tile. For example, when the information about the confidence is greater than a first threshold, it may be considered that the tile may be used for the highest level of intelligent driving. When the information about the confidence is less than or equal to the first threshold and is greater than a second threshold, it may be considered that the tile may be used for a medium level of intelligent driving. When the information about the confidence is less than a third threshold, it may be considered that the tile may be used only for a lowest level of intelligent driving. The first threshold is greater than the second threshold, and the second threshold is greater than the third threshold. A specific threshold may be set based on an actual requirement. This is not limited herein.

In a specific implementation process, with reference to the manner B1, the information about the confidence may be determined by the map OTA client. Therefore, the map OTA client may send the information about the confidence of the tile to a module for an intelligent driving function and/or another function, so that the modules may determine a usable intelligent driving function based on the information about the confidence of the tile. In some other embodiments, alternatively, after determining, based on the information about the confidence of the tile, a level of intelligent driving that can be used by the vehicle, the map OTA client may send the level of intelligent driving that can be used to a corresponding module, so that the module enables, according to a received instruction of the level of intelligent driving of the OTA client, a function of a level that is equal to or lower than the level of intelligent driving.

With reference to the manner B2, the information about the confidence may be determined by the server and sent to the map OTA client on the vehicle. For a manner in which the server determines the information about the confidence, refer to the foregoing manner in which the vehicle determines the information about the confidence. Details are not described herein again.

For another example, the vehicle may alternatively determine, based on the information about the confidence of the tile, a driving mode suitable for the vehicle. For example, at present, most vehicles can use three driving modes, that is, Sport, Normal, and Eco. Clearly, with development of vehicle technologies, more other possible driving modes may be developed. This is not limited herein in this application. A vehicle has different acceleration and deceleration/braking levels in the foregoing three driving modes. Therefore, when the vehicle is moving, there are different requirements on tiles. For example, in the Sport mode, the vehicle has fastest acceleration and deceleration, that is, time for acceleration/deceleration is short, and the vehicle can accelerate or decelerate quickly, so that the vehicle can adapt to a scenario in which a road condition is complex, there are a large quantity of curves, and a road type is frequently switched. Therefore, a tile needs to be of high definition, that is, there needs to be information about high confidence of the tile. There is a high requirement on the tile, especially when a current road condition corresponding to the tile is complex. Compared with the Sport mode, the Normal mode of the vehicle has slower acceleration and deceleration. In the Eco mode, the vehicle has slow acceleration and deceleration, and the mode is a mode, in the three modes, with slowest acceleration and deceleration. In this mode, it takes more time for the vehicle to accelerate or decelerate. If in a tile, there is a case in which, for example, lanes are frequently switched, and there is/are a viaduct or a plurality of curves, this is not helpful for improving driving experience. In this case, when there is information about low confidence of the tile, the Eco mode may not be suitable. Therefore, the vehicle may correspondingly set a suitable driving mode based on information about confidence of different tiles. Further, a more suitable driving mode may be selected when a navigation path in a different case is selected, to improve driving experience.

For another example, the driving mode may be further divided based on different modes of autonomous driving, for example, may include modes such as manual driving, autonomous driving, and long-distance continuous autonomous driving. In this case, the vehicle may determine a suitable driving mode based on the information about the confidence and the current navigation path. For example, it is assumed that the current navigation path is related to information about high confidence of a tile, and a requirement of the autonomous driving mode is satisfied. In this case, it may be determined that a current driving mode can support the autonomous driving mode. It is assumed that information about confidence of a tile corresponding to only 20% of a road on the navigation path satisfies the requirement of the autonomous driving mode. When the vehicle selects the current navigation path, a suggestion for lowering a level of a current driving mode is provided. For another example, if it is determined that information about confidence of a tile corresponding to a continuous road on the navigation path satisfies the requirement of the autonomous driving mode, that is, if there is a sub-path with a value greater than a threshold for autonomous driving, the sub-path may be displayed to a user when the target vehicle arrives at a range of the sub-path, to prompt the user that there is the sub-path for selecting the autonomous driving mode. Different navigation path selection conditions may be correspondingly set for different driving modes, to adapt to different driving modes and further improve performance of navigation path planning.

### Embodiment 3

This application provides a map-based driving decision-making method. The method may be applied to a scenario shown in FIG. 1. A server and a terminal may be included in the scenario. For example, the terminal may be a to-be-updated vehicle. The server may include an OTA server that provides an update service for the vehicle and a map server that provides map information for the vehicle. It should be noted that, the OTA server and the map server may be separately deployed servers, or may be centrally deployed servers. This is not limited herein. The vehicle may be disposed with a map update module (for example, a map OTA client). The map OTA client may be disposed on an ECU related to a map, for example, disposed on an ECU corresponding to a navigation map module, or disposed on an ECU corresponding to a map module. This is not limited herein. In a possible scenario, the map OTA client may interact with the server, to update the ECU related to the map and update map data. In another possible scenario, map data may alternatively be updated by a vehicle OTA update. In this case, a vehicle end may include a master node and a slave node. An update of the map data may be a part of the vehicle OTA update. The map OTA client may serve as an OTA slave node and interact with a vehicle OTA master node. The vehicle OTA master node may interact with the server, to update the map-related ECU and update the map data.

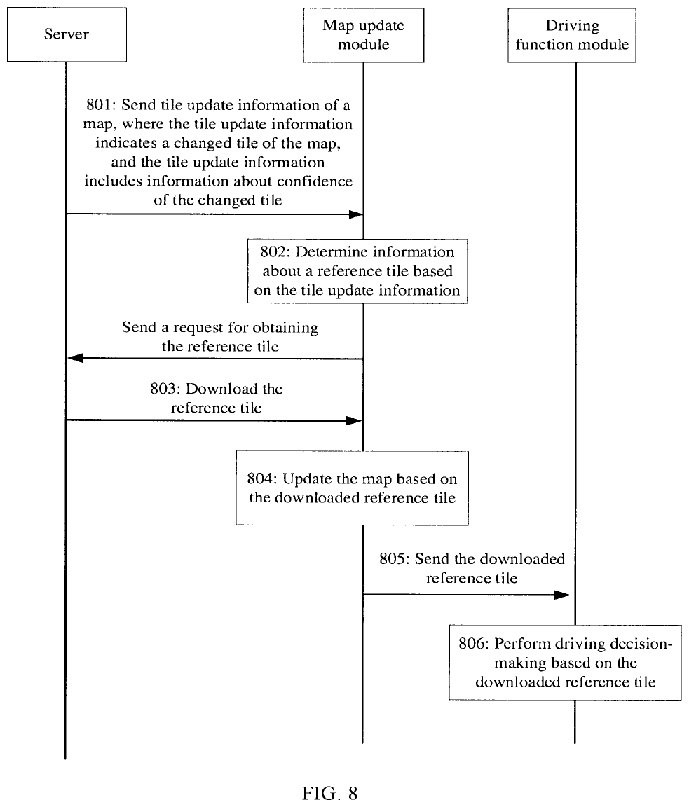

The method provided in this embodiment of this application is described below in detail with reference to a flowchart shown in FIG. 8. As shown in FIG. 8, the following steps are included.

Step 801: The vehicle obtains tile update information of a map.

The tile update information of the map includes at least one of the following: information about a changed tile of the map, information about a similarity between the changed tile of the map and a tile locally stored on the vehicle, and information about confidence of the changed tile.

For a manner in which the vehicle obtains the information about the changed tile of the map, refer to step 401. Details are not described herein again.

For a manner in which the vehicle obtains the information about the similarity between the changed tile of the map and the tile stored on the vehicle, refer to step 601. Details are not described herein again.

Step 802: The vehicle determines information about a reference tile based on the tile update information of the map.

The reference tile is a part of tiles in the changed tile.

With reference to the manner B 1, the map update module on the vehicle may determine the reference tile based on the information about the changed tile of the map and the similarity information of the tile.

Alternatively, the map update module on the vehicle may determine the reference tile based on the information about the changed tile of the map and the information about the confidence of the tile.

Optionally, the map update module on the vehicle may determine, based on the information about the changed tile of the map and the similarity information of the tile, information about confidence of the locally stored tile.

Optionally, the map update module on the vehicle may determine the information about the confidence of the changed tile based on the information about the changed tile of the map and the similarity information of the tile. The map update module on the vehicle may determine the reference tile and a strategy of updating the reference tile based on the information about the confidence of the changed tile.

Optionally, the vehicle sends, based on the determined reference tile and/or the strategy of updating the reference tile, a request for obtaining the reference tile to the server, so that the vehicle downloads the reference tile from the server.

In some embodiments, the vehicle may determine an order of downloading/updating the reference tile or a priority of downloading/updating the reference tile based on a pinpointed location and a navigation path of the vehicle and the information about the similarity between the changed tile of the map and the tile stored on the vehicle.

For example, the vehicle may determine a moving path of the vehicle based on the pinpointed location and the navigation path of the vehicle; and determine the order of updating the reference tile or the priority of updating the reference tile based on the moving path of the vehicle and information about a similarity between the reference tile and the tile stored on the vehicle.

For example, the vehicle may use a tile with information about confidence of the tile less than a first update threshold as a tile to be preferentially updated, and use a tile with information about confidence of the tile greater than a second update threshold as a tile to be finally updated. The first update threshold may be less than or equal to the second update threshold.

For another example, all changed tiles of the map may alternatively be determined as the reference tile, and a strategy of updating the reference tile may be determined based on an order, of information about confidence, that is obtained based on information about confidence of the tiles. For example, the strategy of updating the reference tile may include that the changed tiles of the map are sequentially updated in ascending order. Clearly, the priority of updating may be further divided based on the order of the information about the confidence, to determine, based on an order of priorities, an order of updating the reference tile.

In some other embodiments, the strategy of updating the reference tile may alternatively be determined based on the information about the confidence of the tile and a usage range of the map.

For example, the vehicle may determine, based on the usage range, of the map, determined based on the navigation path and information about confidence of the to-be-updated tile, a strategy of updating the to-be-updated tile.

In other words, the reference tile may be determined based on the usage range, of the map, determined based on the navigation path. For example, the reference tile includes a tile 1, a tile 2, a tile 3, and a tile 4. Further, the information about the confidence of the reference tile is determined. When the information about the confidence of the reference tile is greater than the first update threshold, it may be determined that the priority of updating the reference tile is the highest. When the information about the confidence of the reference tile is less than the second update threshold, it may be determined that the priority of updating the reference tile is the lowest. For example, if information about confidence of the tile 1 is 95%, it may be determined that a priority of updating the tile 1 is the lowest, or it may be determined that the tile 1 is not a to-be-updated tile. If information about confidence of the tile 2 is 80%, it may be determined that a priority of updating the tile 2 is a medium priority. If information about confidence of both the tile 3 and the tile 4 is less than 60%, it may be determined that a priority of updating the tile 3 and the tile 4 is a highest priority. Therefore, the determined reference tile may include the tile 2, the tile 3, and the tile 4. The order of updating may be the tile 4, the tile 3, and the tile 2 sequentially.

Further, an order of using the reference tile may be further considered, to further determine the strategy of updating the reference tile. With reference to the foregoing example, it may be determined that an order of using the tile 2, the tile 3, and the tile 4 is the tile 24 the tile 34 the tile 4. Therefore, the order of downloading/updating may be the tile 3, the tile 2, and the tile 4 sequentially.

In this process, for the strategy of updating the reference tile, refer to the strategy of updating the to-be-updated tile. Details are not described herein again.

Step 803: The vehicle downloads the reference tile from the server.

With reference to step 802, for example, the vehicle may send, based on the determined reference tile and/or the strategy of updating the reference tile, the request for obtaining the reference tile to the server, so that the vehicle downloads the reference tile from the server.

With reference to step 802, for another example, the vehicle may send the strategy of updating to the server, so that the server sends the reference tile to the vehicle according to the strategy of updating.

For details, refer to step 403. Details are not described herein again.

Step 804: The vehicle updates the map based on the downloaded reference tile.

For a specific manner in which the vehicle updates the map based on the downloaded reference tile, refer to the manner of downloading the to-be-updated tile in step 404. Details are not described herein again.

Optionally, after successfully updating the map based on the reference tile, the vehicle updates at least one of an identifier of a locally stored to-be-updated tile, the information about the similarity between the changed tile of the map and the tile stored on the vehicle, information about confidence of the to-be-updated tile, and the like.

In some embodiments, the map OTA client may update the information about the confidence of the locally stored tile based on updated information about the reference tile. For example, updated information about the confidence of the reference tile may be set to a maximum value, so that the updated information about the confidence of the reference tile is sent to a corresponding module for a driving function, so that the module may implement a corresponding driving decision-making function by using an updated reference tile based on the updated information about the confidence of the reference tile.

Step 805: The downloaded reference tile is sent to a driving function module on the vehicle.

In a possible implementation, the map update module on the vehicle may send the downloaded information about the reference tile to the driving function module on the vehicle. For example, the information about the reference tile includes at least one of the following: a version of the reference tile, data of the reference tile, information about a similarity between the changed tile of the map and the reference tile locally stored on the vehicle, and the information about the confidence of the reference tile.

Optionally, after updating the identifier of the locally stored reference tile and the information about the confidence of the reference tile, the map update module on the vehicle may further send the updated information about the confidence of the reference tile to the driving function module on the vehicle.

Step 806: The driving function module on the vehicle performs driving decision-making based on the downloaded reference tile.

For example, the driving function module on the vehicle selects, based on the downloaded information about the confidence of the reference tile and information about confidence of another tile stored on the vehicle, a tile that satisfies a confidence requirement, to perform driving decision-making.

For a specific implementation, refer to the manner of performing driving decision-making based on the information about the confidence of the changed tile of the map and of the locally stored tile in step 702, or refer to the manner of performing driving decision-making based on the updated map in step 404, or refer to a combination of the two manners. The manner may be determined based on an actual requirement, and details are not described herein again.

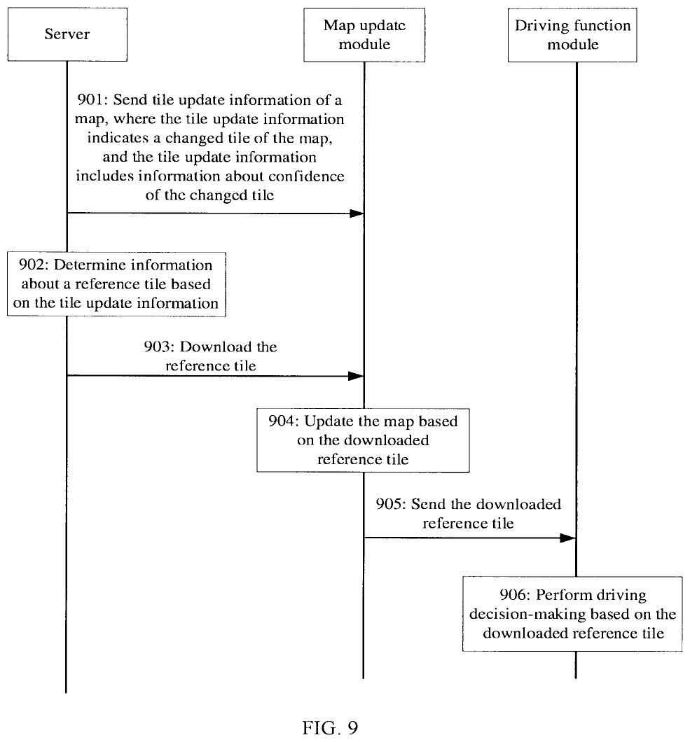

A method provided in this embodiment of this application is described below in detail with reference to a flowchart shown in FIG. 9. As shown in FIG. 9, the following steps are included.

Step 901: A vehicle obtains tile update information of a map.

In some embodiments, the tile update information indicates a changed tile of the map. A server may send the tile update information of the map to the vehicle. The tile update information of the map includes at least one of the following: information about a changed tile of the map, information about a similarity between the changed tile of the map and a tile locally stored on the vehicle, information about confidence of the changed tile, and information about confidence of the tile locally stored on the vehicle.

For a manner in which the vehicle obtains the information about the changed tile of the map, refer to step 401. Details are not described herein again. Optionally, the server may determine, based on the information about the changed tile of the map and the similarity information of the tile, information about confidence of the tile locally stored on the vehicle.

For a manner in which the vehicle obtains the information about the similarity between the changed tile of the map and the tile stored on the vehicle, refer to step 601. Details are not described herein again.

Step 902: The server determines information about a reference tile based on the tile update information of the map.

With reference to the manner B2, the server may determine the reference tile based on the information about the changed tile of the map and the information about the confidence of the tile. The server may determine the reference tile and a strategy of updating the reference tile based on the information about the confidence of the locally stored tile. Optionally, the server may determine, based on the information about the changed tile of the map and the similarity information of the tile, the information about the confidence of the changed tile. The server determines the reference tile and the strategy of updating the reference tile based on the information about the confidence of the changed tile. For a specific manner in which the server determines the reference tile, refer to the manner in which the vehicle determines the to-be-updated tile. Details are not described herein again.

Step 903: The vehicle downloads the reference tile from the server.

With reference to step 902, the server may send the reference tile to the vehicle based on the determined reference tile and/or the strategy of updating the reference tile.

For details, refer to the strategy of updating the to-be-updated tile in step 403 and step 503. Details are not described herein again.

Step 904: The vehicle updates the map based on the downloaded reference tile.

For a specific manner of updating the map based on the reference tile downloaded by the vehicle, refer to the manner of updating the map based on the to-be-updated tile in step 404 and step 504. Details are not described herein again.

Optionally, after the vehicle successfully updates the map based on the reference tile, the vehicle updates at least one of an identifier of a locally stored to-be-updated tile, the information about the similarity between the changed tile of the map and the tile stored on the vehicle, information about confidence of the reference tile, and the like.

In some embodiments, the map OTA client may update the information about the confidence of the locally stored tile based on the information about the reference tile. For example, the information about the confidence of the reference tile may be set to a maximum value, so that the information about the confidence of the reference tile is sent to a corresponding module for a driving function, so that the module may implement a corresponding driving decision-making function by using the reference tile based on the information about the confidence of the reference tile.

Step 905: The downloaded reference tile is sent to a driving function module on the vehicle.

In a possible implementation, the map update module on the vehicle may send the information about the reference tile to the driving function module on the vehicle. For example, the information about the reference tile includes at least one of the following: a version of the reference tile, data of the reference tile, information about a similarity between the changed tile of the map and the reference tile locally stored on the vehicle, and the information about the confidence of the reference tile locally stored on the vehicle.

Optionally, after updating the identifier of the locally stored to-be-updated tile and the information about the confidence of the to-be-updated tile, the map update module on the vehicle may further send the information about the confidence of the reference tile to the driving function module on the vehicle.

Step 906: Driving decision-making is performed based on the downloaded reference tile.

For example, the driving function module on the vehicle performs driving decision-making based on the reference tile. For another example, the driving function module on the vehicle selects, based on the information about the confidence of the reference tile and information about confidence of another tile stored on the vehicle, a tile that satisfies a confidence requirement, to perform driving decision-making.

For a specific implementation, refer to the manner of performing driving decision-making based on the information about the confidence of the changed tile of the map and of the locally stored tile in step 702, or refer to the manner of performing driving decision-making based on the updated map in step 405 and step 505, or refer to a combination of the two manners. The manner may be determined based on an actual requirement, and details are not described herein again.

Optionally, when there is more than one navigation path, a path including a tile with information about high confidence may be further selected as the navigation path based on information about confidence of a tile related to the navigation path. Alternatively, when there is more than one navigation path, a path of a high similarity may be further selected as the navigation path based on information about a similarity between a tile related to the navigation path and the changed tile of the map.

For example, a navigation map module determines that there are K optional paths currently, and may determine, based on a usage range, of the map, related to each path in the K paths, a tile related to the usage range of the map. In this way, information about confidence corresponding to each of the paths may be determined based on information about confidence of the tile related to each of the paths. Further, the vehicle may select, based on the information about the confidence of the tile related to each of the paths, a path with information about high confidence as the navigation path.

For example, a tile related to a path 1 includes a tile 1-1, a tile 1-2, and a tile 1-3. A tile related to a path 2 includes a tile 2-1, a tile 2-2, and a tile 2-3. Information about confidence of the tile 1-1 is 90%, information about confidence of the tile 1-2 is 80%, and information about confidence of the tile 1-3 is 85%. In this case, information about confidence of the path 1 may be 85%. Information about confidence of the tile 2-1 is 40%, information about confidence of the tile 2-2 is 80%, and information about confidence of the tile 2-3 is 60%. In this case, information about confidence of the path 1 may be 60%. Therefore, the path 1 may be selected to be the navigation path, and a changed tile, of the map, related to the path 1 is preferentially downloaded.

Optionally, a changed tile, of the map, with a high safety coefficient may be preferentially downloaded and used as the to-be-updated tile based on a safety coefficient corresponding to a tile, and after an update is completed, a path corresponding to the updated tile is preferentially used.

For example, information about the to-be-updated tile includes a weather condition, a traffic congestion condition, a road type, and the like of a special road (a tunnel 1). In this case, it may be determined that the safety coefficient of the to-be-updated tile is high, information about confidence of the tile may be set to a low level, and a priority of downloading the tile may be set to a high priority.

After the tile is updated, the information about the confidence of the tile may be updated to a higher level, and the updated tile is preferentially used for planning the navigation path.

For example, after the tile is updated, it may be determined that the tunnel 1 is currently a road that is impassable or that is recommended to be avoided. It is assumed that usability information of the tunnel 1 corresponding to the updated tile includes information that the tunnel is impassable with a rainstorm alert, exceeded flood alert level, or the like, and it may be determined that the tunnel 1 is currently an impassable road. A map module may select from other tunnels or river-crossing bridges near the tunnel 1, and determine whether another tunnel or river-crossing bridge near the tunnel 1 is passable. If it is determined that the another tunnel or river-crossing bridge near the tunnel 1 is also impassable, lane-level road information, of an initial path, that may be returned to the navigation map module may include that the tunnel 1 is impassable and the nearby tunnel or river-crossing bridge is impassable. In this way, the navigation map module may re-plan, based on the information, a sub-road section corresponding to the tunnel 1 on the initial path, to avoid the impassable tunnel 1 and the another impassable tunnel or river-crossing bridge nearby.

For another example, it is determined, based on the information about the to-be-updated tile that includes a traffic congestion condition, a road type, and the like, that a lane on which the vehicle corresponding to a sub-path 1 on the navigation path is located or a lane at which the vehicle is expected to arrive is a lane that is impassable or that is recommended to be avoided. It is assumed that usability information of the sub-path 1 includes that a lane 1 is severely congested, a lane 2 is congested, and a lane 3 is not congested. In this case, it may be determined that the lane 1 is currently a lane that is recommended to be avoided. The vehicle may select from other lanes near the tunnel 1 based on the updated tile, to determine congestion conditions of the other lanes near the lane 1. It is determined that the congestion conditions of the other lanes near the lane 1 are that the lane 2 is congested, the lane 3 is not congested. Further, the vehicle may recommend a user to change lanes, for example, may recommend the user to change to the lane 2 or the lane 3.

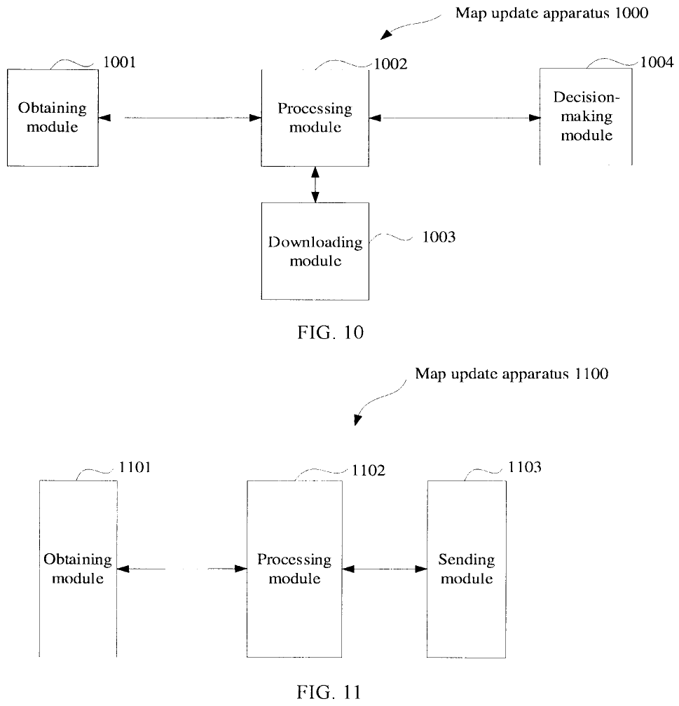

An embodiment of this application further provides a map update apparatus. The map update apparatus is configured to implement a map update function described in FIG. 4 or FIG. 5. Refer to FIG. 10, the map update apparatus 1000 includes an obtaining module 1001, a processing module 1002, a downloading module 1003, and a decision-making module 1004.

The obtaining module 1001 is configured to obtain tile update information of a map, where the tile update information indicates a changed tile of the map.

The processing module is 1002 configured to: determine a to-be-updated tile based on a pinpointed location of the vehicle, a navigation path of the vehicle, and the tile update information, where the to-be-updated tile is a part of tiles in the changed tile; and update the map based on the downloaded to-be-updated tile.

The downloading module 1003 is configured to download the to-be-updated tile from a server.

The decision-making module 1004 is configured to perform driving decision-making based on the updated map.

In a possible implementation, the processing module 1002 is configured to:

determine, based on the pinpointed location and the navigation path, a tile at which the vehicle is about to arrive; and determine the to-be-updated tile based on the tile at which the vehicle is about to arrive and the changed tile.

In a possible implementation, the processing module 1002 is further configured to determine an order of downloading the to-be-updated tile based on at least one of the following information: a requirement of the driving decision-making on using the to-be-updated tile; a driving type of the vehicle; a data type of the to-be-updated tile; or information about a similarity between the to-be-updated tile and a tile stored on the vehicle.

In a possible implementation, the processing module 1002 is further configured to determine an order of updating the to-be-updated tile based on at least one of the following information: the requirement of the driving decision-making on using the to-be-updated tile; the driving type of the vehicle; the data type of the to-be-updated tile; or the information about the similarity between the to-be-updated tile and the tile stored on the vehicle.

As shown in FIG. 11, an embodiment of this application further provides a map update apparatus 1100, including an obtaining module 1101, a processing module 1102, and a sending module 1103.

The obtaining module 1101 is configured to obtain information about a to-be-updated tile, where the to-be-updated tile is a part of tiles in the changed tile; and the processing module 1102 is configured to: send tile update information of a map to a vehicle by using the sending module 1103, where the tile update information indicates a changed tile of the map; and send the to-be-updated tile to the vehicle by using the sending module.

In a possible implementation, the obtaining module 1101 is configured to obtain a pinpointed location of the vehicle and a navigation path of the vehicle; and the processing module 1102 is configured to determine the to-be-updated tile based on the tile update information, the pinpointed location, and the navigation path.

In a possible implementation, the processing module 1102 is configured to: determine, based on the pinpointed location and the navigation path, a tile at which the vehicle is about to arrive; and determine the to-be-updated tile based on the tile at which the vehicle is about to arrive and the changed tile.

In a possible implementation, the processing module 1102 is further configured to determine an order of downloading the to-be-updated tile based on at least one of the following information: a requirement of the driving decision-making on using the to-be-updated tile; a driving type of the vehicle; a data type of the to-be-updated tile; or information about a similarity between the to-be-updated tile and a tile stored on the vehicle.

In a possible implementation, the processing module 1102 is further configured to determine an order of updating the to-be-updated tile based on at least one of the following information: the requirement of the driving decision-making on using the to-be-updated tile; the driving type of the vehicle; the data type of the to-be-updated tile; or the information about the similarity between the to-be-updated tile and the tile stored on the vehicle.

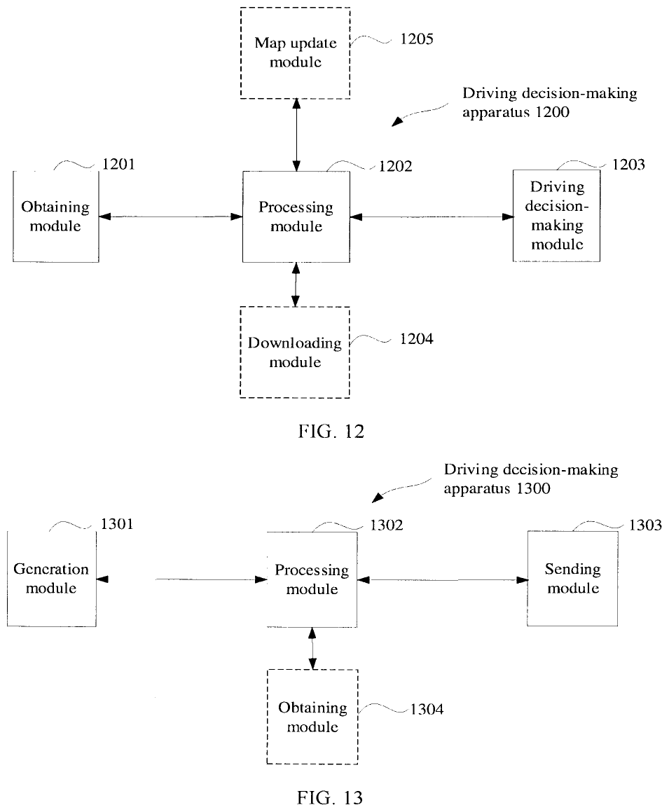

As shown in FIG. 12, this application provides a map-based driving decision-making apparatus 1200 that may specifically include an obtaining module 1201, a processing module 1202, and a driving decision-making module 1203. Optionally, a downloading module 1204 and a map update module 1205 may be further included.

The obtaining module 1201 is configured to obtain tile update information of a map, where the tile update information indicates a changed tile of the map, and the tile update information includes information about confidence of the changed tile; and the driving decision-making module 1203 is configured to select, based on the information about the confidence, a part of tiles in the changed tile to be a reference tile for driving decision-making.

In a possible implementation, the information about the confidence includes information about a similarity of the changed tile before and after the update.

In a possible implementation, the driving decision-making module 1203 is configured to: obtain a pinpointed location of the vehicle and a navigation path of the vehicle by using the obtaining module 1201; determine, based on the pinpointed location and the navigation path, a tile at which the vehicle is about to arrive; and select, from the changed tile, a tile that satisfies confidence information requirement and at which the vehicle is about to arrive, to be the reference tile for driving decision-making.

In a possible implementation, the downloading module 1204 is configured to download the reference tile from a server; and the map update module 1205 is configured to update the map based on the downloaded reference tile.

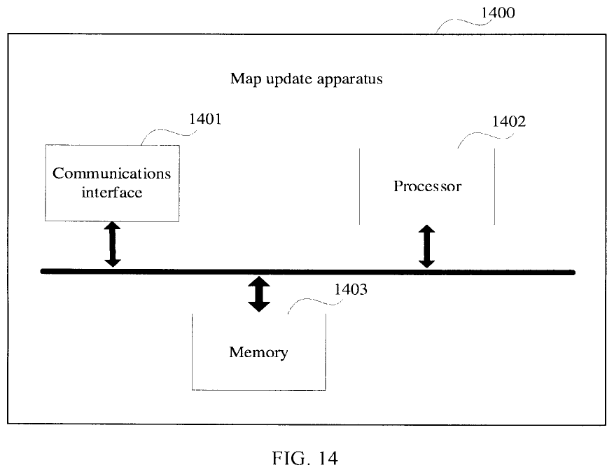

As shown in FIG. 13, an embodiment of this application further provides a map-based driving decision-making apparatus 1300 that may include a generation module 1301, a processing module 1302, and a sending module 1303. Optionally, an obtaining module 1304 may be further included.

The generation module 1301 is configured to: generate tile update information of a map, where the tile update information indicates a changed tile of the map, and the tile update information includes information about confidence of the changed tile; and the processing module 1302 is configured to send the tile update information to a vehicle by using the sending module.

In a possible implementation, the information about the confidence includes information about a similarity of the changed tile before and after the update.

In a possible implementation, the obtaining module 1304 is configured to obtain information about a reference tile, where the reference tile is a part of tiles in the changed tile; and the processing module 1302 is configured to send the reference tile to the vehicle by using the sending module 1303, where the reference tile is the part of tiles in the changed tile.

In a possible implementation, the obtaining module 1304 is configured to obtain a pinpointed location of the vehicle and a navigation path of the vehicle; and the processing module 1302 is configured to: determine, based on the pinpointed location and the navigation path, a tile at which the vehicle is about to arrive; and select, from the changed tile, a tile that satisfies confidence information requirement and at which the vehicle is about to arrive, to be the reference tile for driving decision-making.

It should be noted that, in the foregoing embodiments of this application, the division into the modules is an example and is merely logical function division, and may be other division in an actual implementation. In addition, the functional modules in embodiments of this application may be integrated into one processing unit, each of the units may exist alone physically, or two or more modules are integrated into one module. One or more of the foregoing modules may be implemented by software, hardware, firmware, or a combination thereof. The software or firmware includes, but is not limited to, computer program instructions or code, and may be executed by a hardware processor. The hardware includes, but is not limited to, various types of integrated circuits, for example, a central processing unit (CPU), a digital signal processor (DSP), a field programmable gate array (FPGA), or an application-specific integrated circuit (ASIC).

When implemented in the form of a software functional unit and sold or used as an independent product, the integrated module may be stored in a computer-readable storage medium. Based on such an understanding, the technical solutions of this application essentially, or all or some of the part contributing to the conventional technology, or some of the technical solutions may be implemented in a form of a software product. The computer software product may be stored in a storage medium, and includes several instructions for instructing a computer device (that may be a personal computer, a server, or a network device) or a processor to perform all or some of the steps in the method described in embodiments of this application. The foregoing storage medium includes any medium that can store program code, for example, a USB flash drive, a removable hard disk, a read-only memory (ROM), a random access memory (RAM), a magnetic disk, or an optical disc.

An embodiment of this application further provides a map update apparatus. The map update apparatus may implement the map update function or the map-based driving decision-making function in FIG. 4 or FIG. 5. For example, the map update apparatus may be a vehicle, or may be a server. Refer to FIG. 14. A map update apparatus 1400 includes a communications interface 1401, a processor 1402, and a memory 1403.

The communications interface 1401, the memory 1403, and the processor 1402 are connected to each other. Optionally, the communications interface 1401, the memory 1403, and the processor 1402 may be connected to each other by using a bus. The bus may be a peripheral component interconnect (PCI) bus, an extended industry standard architecture (EISA) bus, or the like. The bus may be classified into an address bus, a data bus, a control bus, and the like. For ease of representation, only one thick line is used for representation in FIG. 14, but this does not mean that there is only one bus or only one type of buses.

The communications interface 1401 is configured for communications of another component in the map update apparatus. For example, the communications interface 1401 may be configured to: obtain tile update information of a map, where the tile update information indicates a changed tile of the map; and download a to-be-updated tile from a server. Alternatively, the communications interface 1401 may be configured to: send tile update information of a map to a vehicle, where the tile update information indicates a changed tile of the map; obtain information about a to-be-updated tile, where the to-be-updated tile is a part of tiles in the changed tile; and send the to-be-updated tile to the vehicle.

The processor 1402 is configured to implement the map update method shown in FIG. 4 or FIG. 5. For details, refer to the descriptions in the embodiment shown in FIG. 4 or FIG. 5. Details are not described herein again. Optionally, the processor 1402 may be a central processing unit (CPU) or another hardware chip. The hardware chip may be an application-specific integrated circuit (ASIC), a programmable logic device (PLD), or a combination thereof. The PLD may be a complex programmable logic device (CPLD), a field programmable gate array (FPGA), generic array logic (GAL), or any combination thereof. The processor 1402 may implement the foregoing functions by using hardware or clearly, by using hardware executing corresponding software.

The memory 1403 is configured to store program instructions, data, and the like. Specifically, the program instructions may include program code, and the program code includes computer operation instructions. The memory 1403 may include a random access memory (RAM), and may further include a non-volatile memory, for example, at least one magnetic disk memory. The processor 1402 executes a program stored in the memory 1403, and implements the foregoing functions by using the foregoing components, to finally implement the methods provided in the foregoing embodiments.

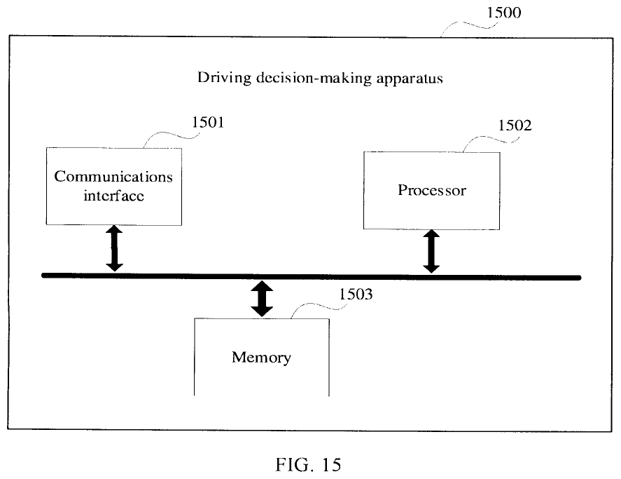

An embodiment of this application further provides a map-based driving decision-making apparatus. The map-based driving decision-making apparatus may implement the driving decision-making function by using a map in FIG. 7, FIG. 8, or FIG. 9. For example, the apparatus may be the vehicle in FIG. 7, FIG. 8, or FIG. 9 or a chip on the vehicle. Alternatively, for example, the apparatus may be the server in FIG. 8 or FIG. 9 or a chip on the server. Refer to FIG. 15. A map-based driving decision-making apparatus 1500 includes a communications interface 1501, a processor 1502, and a memory 1503.

The communications interface 1501, the memory 1503, and the processor 1502 are connected to each other. Optionally, the communications interface 1501, the memory 1503, and the processor 1502 may be connected to each other by using a bus. The bus may be a peripheral component interconnect (PCI) bus, an extended industry standard architecture (EISA) bus, or the like. The bus may be classified into an address bus, a data bus, a control bus, and the like. For ease of representation, only one thick line is used for representation in FIG. 15, but this does not mean that there is only one bus or only one type of buses.

The communications interface 1501 is configured for communications of another component in the map-based driving decision-making apparatus. For example, the communications interface 1501 may be configured to: obtain tile update information of a map, where the tile update information indicates a changed tile of the map, and the tile update information includes information about confidence of the changed tile; or send the tile update information to a vehicle.

The processor 1502 is configured to implement the map-based driving decision-making method shown in FIG. 7, FIG. 8, or FIG. 9. For details, refer to the descriptions in the embodiment shown in FIG. 7. Details are not described herein again. Optionally, the processor 1502 may be a central processing unit (CPU) or another hardware chip. The hardware chip may be an application-specific integrated circuit (ASIC), a programmable logic device (PLD), or a combination thereof. The PLD may be a complex programmable logic device (CPLD), a field programmable gate array (FPGA), generic array logic (GAL), or any combination thereof. The processor 1502 may implement the foregoing functions by using hardware or clearly, by using hardware executing corresponding software.

The memory 1503 is configured to store program instructions, data, and the like. Specifically, the program instructions may include program code, and the program code includes computer operation instructions. The memory 1503 may include a random access memory (RAM), and may further include a non-volatile memory, for example, at least one magnetic disk memory. The processor 1502 executes a program stored in the memory 1503, and implements the foregoing functions by using the foregoing components, to finally implement the methods provided in the foregoing embodiments.

Based on the foregoing embodiments, an embodiment of this application further provides a computer program. When the computer program runs on a computer, the computer is enabled to perform the methods provided in the foregoing embodiments.

Based on the foregoing embodiments, an embodiment of this application further provides a computer storage medium. The computer storage medium stores a computer program. When the computer program is executed by a computer, the computer is enabled to perform the methods provided in the foregoing embodiments.

Based on the foregoing embodiments, an embodiment of this application further provides a chip. The chip is configured to read a computer program stored in a memory, to implement the methods provided in the foregoing embodiments.

Based on the foregoing embodiments, an embodiment of this application provides a chip system. The chip system includes a processor, configured to support a computer apparatus in implementing a function related to a high-definition map generation apparatus and/or a function of a positioning apparatus in the methods provided in the foregoing embodiments. In a possible design, the chip system further includes a memory, and the memory is configured to store a program and data needed by the computer apparatus. The chip system may include a chip, or may include a chip and another discrete device.

A person skilled in the art should understand that embodiments of this application may be provided as a method, a system, or a computer program product. Therefore, this application may use a form of a hardware-only embodiment, a software-only embodiment, or an embodiment in a combination of software and hardware. In addition, this application may use a form of a computer program product implemented on one or more computer-usable storage media (including, but not limited to, a disk memory, a CD-ROM, an optical memory, and the like) that include computer-usable program code.

This application is described with reference to the flowcharts and/or block diagrams of the method, the device (system), and the computer program product according to this application. It should be understood that computer program instructions may be used to implement each procedure and/or each block in the flowcharts and/or the block diagrams and a combination of the procedure and/or the block in the flowcharts and/or the block diagrams. The computer program instructions may be provided to a general-purpose computer, a dedicated computer, an embedded processor or a processor of another programmable data processing device to generate a machine, so that the instructions are executed by the computer or the processor of the another programmable data processing device to generate an apparatus for implementing a specific function in one or more procedures in the flowcharts and/or in one or more blocks in the block diagrams.

The computer program instructions may alternatively be stored in a computer-readable memory that can guide the computer or the another programmable data processing device to work in a specific manner, so that the instructions stored in the computer-readable memory are used to generate an artifact that includes an instruction apparatus. The instruction apparatus implements a specific function in one or more procedures in the flowcharts and/or in one or more blocks in the block diagrams.

The computer program instructions may alternatively be loaded onto the computer or the another programmable data processing device, so that a series of operations and steps are performed on the computer or the another programmable device to generate computer-implemented processing. Therefore, the instructions executed on the computer or the another programmable device provide steps for implementing the specific function in one or more procedures in the flowcharts and/or in one or more blocks in the block diagrams.

Clearly, a person skilled in the art may make various changes and variations to this application without departing from the protection scope of this application. This application is intended to cover these modifications and variations to this application provided that the modifications and variations fall within the scope of protection defined by the claims of this application and their equivalent technologies.

What is claimed is:

1. A map update apparatus, applied to a vehicle and comprising at least one processor and at least one memory, wherein the at least one memory stores program instructions, and the at least one processor is coupled to the at least one memory to execute the instructions to:
obtain tile update information of a map, wherein the tile update information indicates a changed tile of the map;
determine a to-be-updated tile based on a pinpointed location of the vehicle, a navigation path of the vehicle, and the tile update information, wherein the to-be-updated tile is a part of tiles in the changed tile;
download the to-be-updated tile from a server;
update the map based on the downloaded to-be-updated tile; and
perform driving decision-making based on the updated map.

2. The apparatus according to claim 1, wherein the at least one processor is coupled to the at least one memory to execute the instructions to:
determine, based on the pinpointed location and the navigation path, a tile at which the vehicle is about to arrive; and
determine the to-be-updated tile based on the tile at which the vehicle is about to arrive and the changed tile.

3. The apparatus according to claim 1, wherein the at least one processor is coupled to the at least one memory to execute the instructions to: determine an order of downloading the to-be-updated tile based on at least one of the following information:
a requirement of the driving decision-making on using the to-be-updated tile;
a driving type of the vehicle;
a data type of the to-be-updated tile; or
information about a similarity between the to-be-updated tile and a tile stored on the vehicle.

4. The apparatus according to claim 1, wherein the at least one processor is coupled to the at least one memory to execute the instructions to: determine an order of updating the to-be-updated tile based on at least one of the following information:
a requirement of the driving decision-making on using the to-be-updated tile;
a driving type of the vehicle;
a data type of the to-be-updated tile; or
information about a similarity between the to-be-updated tile and a tile stored on the vehicle.

5. The apparatus according to claim 1, wherein the at least one processor is coupled to the at least one memory to execute the instructions to:
determine a priority of using the to-be-updated tile corresponding to driving decision-making performed by the vehicle, based on the area at which the vehicle is about to arrive;
determine a priority of downloading the to-be-updated tile or a priority of using the to-be-updated tile for updating the map, based on the priority of using the to-be-updated tile.

6. A map update apparatus, applied to a server and comprising at least one processor and at least one memory, wherein the at least one memory stores program instructions, and the at least one processor is coupled to the at least one memory to execute the instructions to:
send tile update information of a map to a vehicle, wherein the tile update information indicates a changed tile of the map;
obtain information about a to-be-updated tile, wherein the to-be-updated tile is a part of tiles in the changed tile; and
send the to-be-updated tile to the vehicle.

7. The apparatus according to claim 6, wherein the at least one processor is coupled to the at least one memory to execute the instructions to:
obtain a pinpointed location of the vehicle and a navigation path of the vehicle; and
determine the to-be-updated tile based on the tile update information, the pinpointed location, and the navigation path.

8. The apparatus according to claim 7, wherein the at least one processor is coupled to the at least one memory to execute the instructions to:
determine, based on the pinpointed location and the navigation path, a tile at which the vehicle is about to arrive; and
determine the to-be-updated tile based on the tile at which the vehicle is about to arrive and the changed tile.

9. The apparatus according to claim 6, wherein the at least one processor is coupled to the at least one memory to execute the instructions to: determine an order of downloading the to-be-updated tile based on at least one of the following information:
a requirement of the driving decision-making on using the to-be-updated tile;
a driving type of the vehicle;
a data type of the to-be-updated tile; or
information about a similarity between the to-be-updated tile and a tile stored on the vehicle.

10. The apparatus according to claim 6, wherein the at least one processor is coupled to the at least one memory to execute the instructions to: determine an order of updating the to-be-updated tile based on at least one of the following information:
the requirement of the driving decision-making on using the to-be-updated tile;
the driving type of the vehicle;
the data type of the to-be-updated tile; or
the information about the similarity between the to-be-updated tile and the tile stored on the vehicle.

11. The apparatus according to claim 6, wherein the at least one processor is coupled to the at least one memory to execute the instructions to:
receive the information about the to-be-updated tile from the vehicle, wherein the information about the to-be-updated tile is determined based on the tile update information, the pinpointed location of the vehicle, and the navigation path of the vehicle

12. A map-based driving decision-making apparatus, applied to a vehicle and comprising at least one processor and at least one memory, wherein the at least one memory stores program instructions, and the at least one processor is coupled to the at least one memory to execute the instructions to:
obtain tile update information of a map, wherein the tile update information indicates a changed tile of the map, and the tile update information comprises information about confidence of the changed tile; and
select, based on the information about the confidence, a part of tiles in the changed tile to be a reference tile for driving decision-making.

13. The apparatus according to claim 12, wherein the information about the confidence comprises information about a similarity of the changed tile before and after the update.

14. The apparatus according to claim 12, wherein the at least one processor is coupled to the at least one memory to execute the instructions to:
obtain a pinpointed location of the vehicle and a navigation path of the vehicle; and
determine, based on the pinpointed location and the navigation path, a tile at which the vehicle is about to arrive; and
select, from the changed tile, a tile that satisfies confidence requirement and at which the vehicle is about to arrive, to be the reference tile for driving decision-making.

15. The apparatus according to claim 12, wherein the at least one processor is coupled to the at least one memory to execute the instructions to:
download the reference tile from a server; and
update the map based on the downloaded reference tile.

16. The apparatus according to claim 12, wherein the at least one processor is coupled to the at least one memory to execute the instructions to:
send a request for obtaining the reference tile to the server

17. The apparatus according to claim 16, wherein the request for obtaining the reference tile indicates an order of downloading, or a priority of downloading, the reference tile.

18. The apparatus according to claim 12, wherein the at least one processor is coupled to the at least one memory to execute the instructions to:
determine an order of downloading the reference tile, based on at least one of the following information: a requirement of the driving decision-making on using the reference tile; a driving type of the vehicle; a data type of the reference tile; or the information about the confidence.

19. The apparatus according to claim 12, wherein the at least one processor is coupled to the at least one memory to execute the instructions to:
determine an order of updating the reference tile, based on at least one of the following information: the requirement of the driving decision-making on using the reference tile; the driving type of the vehicle; the data type of the reference tile; or the information about the confidence.

20. The apparatus according to claim 12, wherein the at least one processor is coupled to the at least one memory to execute the instructions to:
determine the information about the confidence of the tile of the map based on the information about the similarity between the to-be-updated tile and the tile stored on the vehicle.
